(19) United States
(12) Patent Application Publication
(10) Pub. No.: US 2013/0085778 A1
(43) Pub. Date: Apr. 4, 2013

(54) ELECTRONIC MEDICAL CHART

(71) Applicants: Timothy GUERTIN, Saratoga, CA (US); Brian Spatola, Huntington Beach, CA (US); Ross B. Hannibal, Saratoga, CA (US); Paul Yokoyama, Henderson, NV (US)

(72) Inventors: Timothy GUERTIN, Saratoga, CA (US); Brian Spatola, Huntington Beach, CA (US); Ross B. Hannibal, Saratoga, CA (US); Paul Yokoyama, Henderson, NV (US)

(73) Assignee: Varian Medical Systems, Inc., Palo Alto, CA (US)

(21) Appl. No.: 13/419,285

(22) Filed: Mar. 13, 2012

Related U.S. Application Data
(63) Continuation-in-part of application No. 13/251,133, filed on Sep. 30, 2011.

(51) Int. Cl. G06Q 50/24

(52) U.S. Cl. 705/3

(57) ABSTRACT

A handheld electronic device includes a network communication device for wirelessly receiving information regarding a plurality of tasks involved in a treatment process for a patient from a database, a processor for processing the information regarding the plurality of tasks, a housing containing the processor, wherein the housing is configured for handheld, and a screen configured to display a graphic using the information regarding the plurality of tasks, the graphic indicating the plurality of tasks on respective dates in a time line.

### FIELD

This application relates generally to systems and methods for providing medical information.

### BACKGROUND

Radiation therapy has been employed to treat tumorous tissue. In radiation therapy, a high energy beam is applied from an external source towards the patient. The external source, which may be rotating (as in the case for arc therapy), produces a collimated beam of radiation that is directed into the patient to the target site. The dose and placement of the dose must be accurately controlled to ensure that the tumor receives sufficient radiation, and that damage to the surrounding healthy tissue is minimized.

Implementation of a radiation therapy involves many different tasks performed by different professionals, including doctors, nurses, technicians, treatment planner, etc. By means of non-limiting examples, such tasks may include consultation by a doctor, verification of insurance by a nurse, obtaining imaging (e.g., CT imaging, x-ray, MRI, PET, SPECT, etc.) by a technician, processing of images by another technician, contouring of organ structures by a doctor/technician, treatment planning by a doctor/technician, treatment preparation by nurse(s) and/or technician(s), treatment execution by a doctor/technician, follow-up by a doctor, and pain management by a nurse/doctor, etc.

The different tasks associated with a radiation therapy may be performed at different locations in different facilities, and may be required to be performed by certain due dates before another task may begin. Sometimes, if a person fails to perform a task, others may be unable to perform their tasks because the performance of their tasks may depend from a result of an earlier task. Also, different facilities that are involved in implementing a radiation therapy may not have access to the same information.

Applicant of the subject application determines that it would be desirable to provide a new system and method for allowing individual(s) to access medical information regarding a medical process that involves radiation.

### SUMMARY

In accordance with some embodiments, a handheld electronic device includes a network communication device for wirelessly receiving information regarding a plurality of tasks involved in a treatment process for a patient from a database, a processor for processing the information regarding the plurality of tasks, a housing containing the processor, wherein the housing is configured for handheld, and a screen configured to display a graphic using the information regarding the plurality of tasks, the graphic indicating the plurality of tasks on respective dates in a time line.

In accordance with other embodiments, a method performed by a handheld electronic device includes wirelessly receiving information regarding a plurality of tasks involved in a treatment process for a patient from a database, processing the information regarding the plurality of tasks using a processor, and displaying on a screen a graphic using the information regarding the plurality of tasks, the graphic indicating the plurality of tasks on respective dates in a time line.

In accordance with other embodiments, a computer product includes a non-transitory medium storing a set of instructions, an execution of which causes a process to be performed by a handheld electronic device, the process comprising wirelessly receiving information regarding a plurality of tasks involved in a treatment process for a patient from a database, processing the information regarding the plurality of tasks, and displaying on a screen a graphic using the information regarding the plurality of tasks, the graphic indicating the plurality of tasks on respective dates in a time line.

In accordance with other embodiments, a system includes a processor configured to receive information regarding a plurality of tasks involved in a treatment process for a patient, the tasks associated with respective dates, and a non-transitory medium configured to store the information regarding the plurality of tasks, and the dates, wherein the processor is also configured to receive a request from a handheld device, retrieve the stored information regarding the plurality of tasks and the dates from the non-transitory medium in response to the request, and pass the information regarding the plurality of tasks and the dates downstream for transmission to the handheld device.

In accordance with other embodiments, a method for providing medical information includes receiving information regarding a plurality of tasks involved in a treatment process, the tasks associated with respective dates, storing the information regarding the plurality of tasks and the dates in a non-transitory medium, receiving a request from a handheld device, retrieving the stored information regarding the plurality of tasks and the dates from the non-transitory medium in response to the request, wherein the act of retrieving is performed using a processor, and passing the information regarding the plurality of tasks and the dates downstream for transmission to the handheld device.

In accordance with other embodiments, a computer product includes a non-transitory medium storing a set of instructions, an execution of which causes a process to be performed, the process comprising receive information regarding a plurality of tasks involved in a treatment process, the tasks associated with respective dates, storing the information regarding the plurality of tasks and the dates, receiving a request from a handheld device, retrieving the stored information regarding the plurality of tasks and the dates in response to the request, and passing the information regarding the plurality of tasks and the dates downstream for transmission to the handheld device.

Other and further aspects and features will be evident from reading the following detailed description of the embodiments.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a system for communicating information regarding a radiation process in accordance with some embodiments;

FIG. 2A illustrates a user interface for allowing a user to enter information about a patient in accordance with some embodiments;

FIG. 2B illustrates a user interface for allowing a user to enter information about a patient in accordance with some embodiments;

FIG. 2C illustrates a user interface for allowing a user to enter information about a patient in accordance with some embodiments;

FIG. 2D illustrates an example of a messaging in accordance with some embodiments;

FIG. 3A illustrates an example of a patient summary in accordance with some embodiments;

FIG. 3B illustrates another example of a patient summary in accordance with other embodiments;

FIG. 3C illustrates a user interface for providing test results in accordance with some embodiments;

FIG. 3D illustrates a user interface for providing pathology test results in accordance with some embodiments;

FIG. 4 illustrates an example of a radiotherapy task schedule in accordance with some embodiments;

FIG. 5A illustrates a schedule for a user in accordance with some embodiments;

FIG. 5B illustrates a user interface for allowing a doctor to enter notes regarding task for a patient in accordance with some embodiments;

FIG. 5C illustrates a schedule for a user in accordance with other embodiments;

FIG. 5D illustrates a pop-up screen for displaying information regarding a patient in accordance with some embodiments;

FIG. 5E illustrates a list of tasks for a user of a handheld device in accordance with some embodiments;

FIG. 5F illustrates a list of patients for a doctor in accordance with some embodiments;

FIG. 5G illustrates a user interface for allowing a doctor to type correspondence in accordance with some embodiments;

FIG. 6A illustrates a user interface that includes an image review tab in accordance with some embodiments;

FIG. 6B illustrates a user interface that displays medical images in accordance with some embodiments;

FIG. 6C illustrates another user interface that displays medical images in accordance with some embodiments;

FIG. 7A illustrates a treatment worksheet in accordance with some embodiments;

FIG. 7B illustrates a summary of an initial screening in accordance with some embodiments;

FIG. 7C illustrates another treatment worksheet in accordance with other embodiments;

FIG. 7D illustrates a user interface for allowing a doctor to prescribes target region(s) for imaging and/or treatment in accordance with some embodiments;

FIG. 7E illustrates a user interface for allowing user(s) to sign off on different completed tasks in accordance with some embodiments;

FIGS. 8A-8C illustrate different user interfaces for providing information regarding lab results in accordance with different embodiments; and

FIG. 9 is a block diagram of a computer system architecture, with which embodiments described herein may be implemented.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

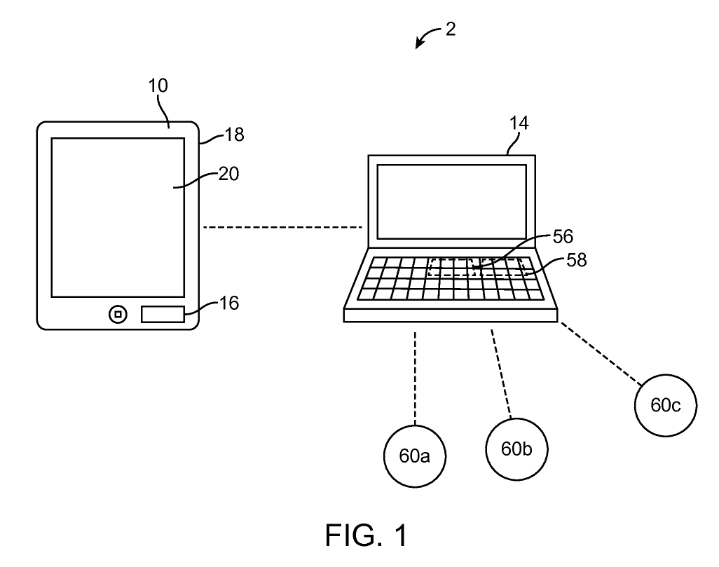

FIG. 1 illustrates a system 2 for communicating medical information in accordance with some embodiments. The system 2 includes a handheld electronic device 10 and a database 14 in communication with the handheld electronic device 10. The device 10 includes a network communication device 12 configured to wirelessly receive medical information (e.g., information regarding a radiation process) from a database 14, a processor 16 configured to process the medical information, a housing 18 containing the processor 16, and a screen 20 configured to display the medical information. In other embodiments, the device 10 may receive the medical information by receiving input from a user of the device 10. In such cases, the processor 16 may process the information, and the network communication device 12 may then transmit the medical information to the database 14 for storage. The housing 16 is configured for handheld, so that a user of the device 10 may carry the device 10 from place to place.

In some embodiments, the device 10 may be a hand-held communication device, such as an iPad, an emailing device (e.g., a Blackberry), or a phone (e.g., iPhone). In other embodiments, the device 10 may be a computer, such as a laptop or a desktop.

In the illustrated embodiments, the database 14 includes a processor 56, and a non-transitory medium 58 for storing medical information (e.g., information regarding a radiation process). In some embodiments, the database 14 may be implemented using one or more computers, which may include respective processors 56. Thus, as used in this specification, the term “processor” or similar terms may refer to one or more processors. Also, in some embodiments, the non-transitory medium 58 may include one or more storage devices, which may be located together (e.g., in a server room), or located in different places (e.g., in different buildings, different cities, etc.). In one implementation, the database 14 may include a plurality of computers that are communicatively linked together in a network.

As shown in the figure, the database 14 may be in communication with a plurality of nodes 60a-60c. Although three nodes 60a-60c are shown, in other embodiments, there may be more than three nodes, or less than three nodes (e.g., one node). Each node 60 may be a source of information. By means of non-limiting examples, each node 60 may be a communication device (e.g., a computer, an iPad, a Blackberry, etc.) at a hospital, at a nurse station, at a doctor's office, at an imaging center, etc. The database 14 is configured to receive various medical information from different nodes 60, process the medical information, and store the medical information in the non-transitory medium 58. During use, the database 14 receives a request from the device 10, retrieves the medical information from the non-transitory medium 58 in response to the request, and transmits the retrieved medical information to the device 10.

Although one device 10 is shown in the figure, in other embodiments, there may be more than one device 10 in communication with the database 14. For example, there may be one device 10 being used by a nurse, another device 10 being used by a doctor, and another device 10 being used by an imaging technician. Also, in other embodiments, one or more of the nodes 60 may be respective device(s) 10. In some embodiments, there may be one or more devices 10 at a nurse station for use by different nurses, one or more devices 10 at a doctor's office for use by different doctors, one or more devices 10 at a lab center for use by different lab technicians, and/or one or more devices 10 at an imaging center for use by different operators. Also, in some embodiments, these professionals may participate in a treatment process (e.g., a radiotherapy process) to treat a patient. In such cases, these professionals may use the devices 10 to enter medical information regarding the patient for storage at the database 14, so that different professionals who participate in the treatment process may retrieve the medical information from the database 14 using their devices 10. All of the input may be stored in a database. In some embodiments, the database may be configured to check for conflicting inputs, and may transmit a warning signal if there is any conflict between inputs. In other embodiments, each person is allowed to enter only certain input so that no two persons will be allowed to enter different inputs for a same field.

In the illustrated embodiments, the device 10 is configured (e.g., programmed, built, etc.) to implement a user interface for presenting medical information to a user of the device 10, and/or receiving medical information from the user of the device 10. As used in this specification, the term “user interface” may refer to one or more graphics configured to provide information to a user, and/or any component (e.g., a screen) for providing such graphics, wherein such graphics may be displayed in a screen (e.g., as one or more pages) or may be stored in a non-transitory medium as data.

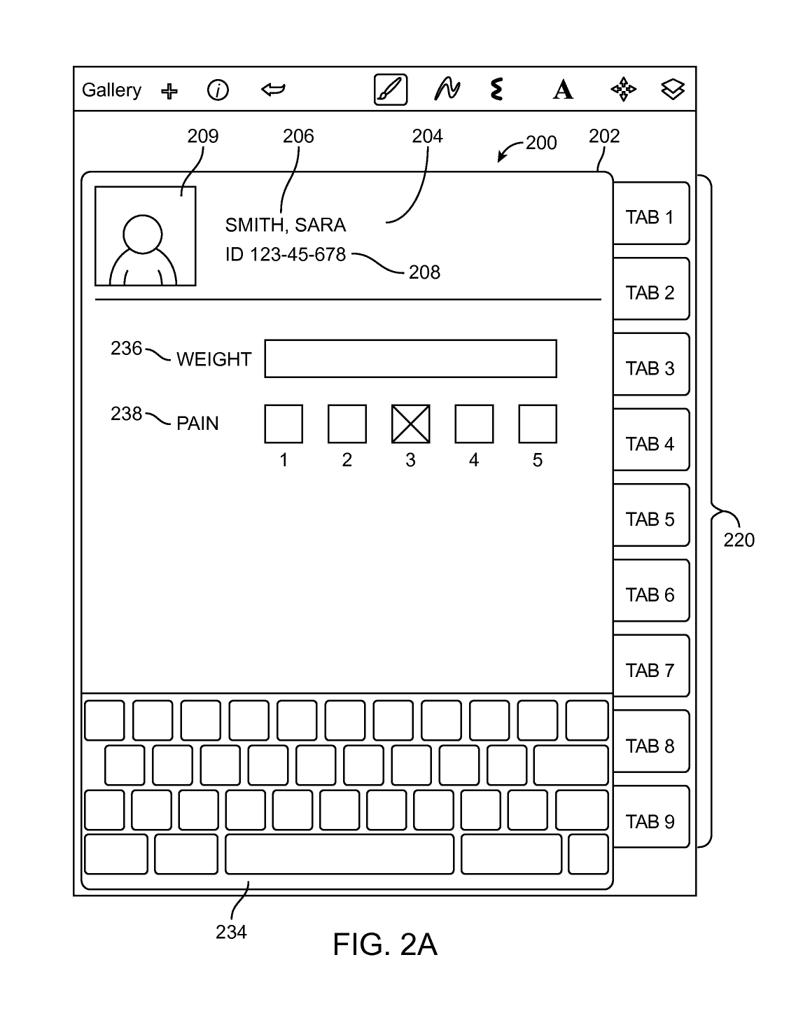

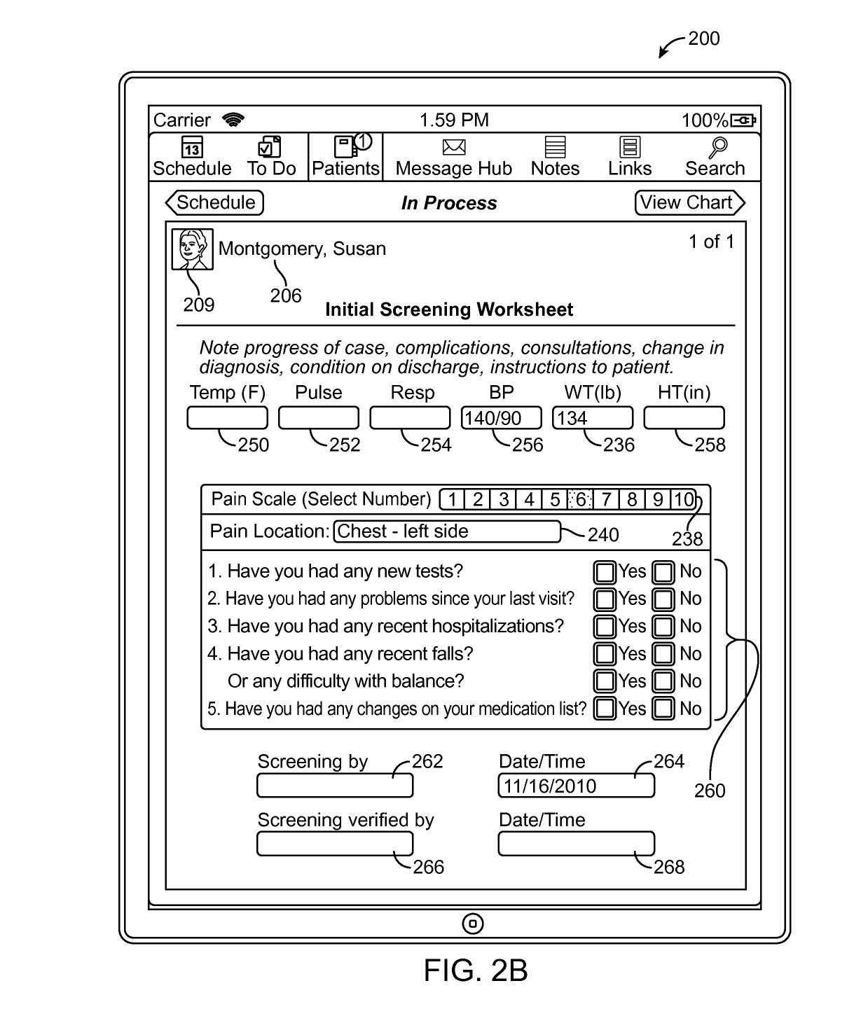

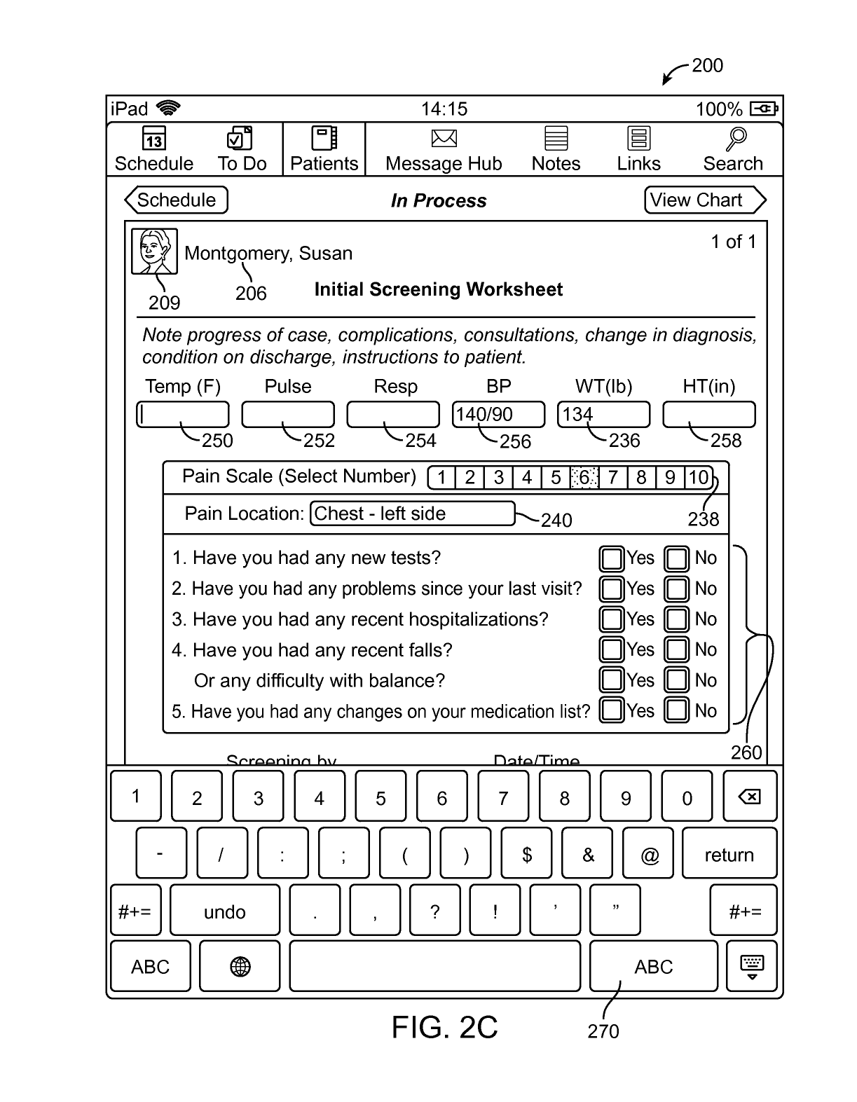

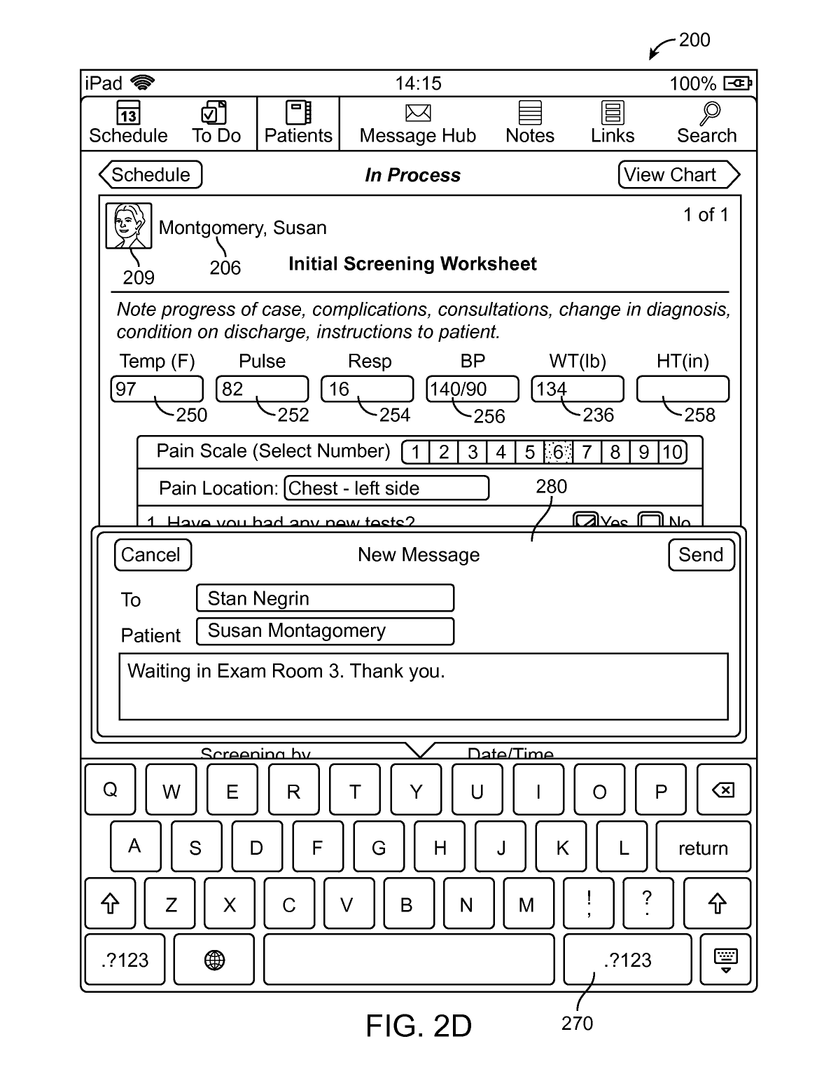

In some embodiments, the device 10 may be an iPad that is configured to display a user interface for presenting and/or receiving medical information. FIG. 2A illustrates an example of a user interface 200 displayed in a screen 202 of an iPad device 10 for presenting medical information in accordance with some embodiments. The user interface 200 includes a display area 204 for displaying a name 206 of a patient, a patient identification 208, and a picture 209 of the patient. The user interface 200 is configured for allowing a user (e.g., a nurse, a doctor, etc.) to input information regarding a patient. In the illustrated embodiments, the user interface 200 includes a keyboard 234 for allowing a user to input information, a field 236 for allowing a user to enter a weight of a patient (e.g., using the keyboard 234), and a field 238 for allowing a user to enter a pain level being experienced by a patient (e.g., using the keyboard 234). For example, the pain level may be due to a result of a radiation treatment. In other embodiments, the user interface 200 may include other fields (e.g., different fields for patient's age, patient's address, patient's symptoms, patient's medical history, physical examination notes, etc.). In some embodiments, after the information has been entered by a user of the device 10, the device 10 then transmits the information to the database 14 for storage at the database 14.

In the illustrated embodiments, the user interface 200 also includes a plurality of tabs 220. Tab 1 corresponds with the display shown in FIG. 2A, such that when a user selects “Tab 1” (e.g., by touching the portion of the screen 202 at which “Tab 1” is displayed), the display shown in FIG. 2A will be displayed to the user. The user may select any of other tabs, in which case, the device 10 will display different screen displays for presenting different information to the user. In some embodiments, the name 206, patient identification 208, and the picture 209 of the patient are displayed to the user of the device 10 regardless of which of the tabs 220 has been selected by the user. In other embodiments, the name 206, patient identification 208, and the picture 209 of the patient are displayed when the user selects only certain one(s) of the tabs 220.

FIG. 2B illustrates another user interface 200 configured for allowing a user (e.g., a nurse, a doctor, etc.) to input information regarding a patient in accordance with other embodiments. In some embodiments, the user interface 200 of FIG. 2B may be displayed for use during an initial screening process. The user interface 200 includes a field 236 for allowing a user of the device 10 to input the weight of the patient, a field 238 (in the form of a selectable scale) for allowing the user to enter a pain level experienced by the patient, and a field 240 for allowing the user to enter the pain location. The user interface 200 also includes multiple fields to input vital info of the patient that includes but not limited to a field 250 for allowing the user to input a temperature of the patient, a field 252 for allowing the user to input a pulse of the patient, a field 254 for allowing the user to input a respiratory rate of the patient, a field 256 for allowing the user to input a blood pressure of the patient, and a field 258 for allowing the user to input a height of the patient. In some embodiments, one or more of the information for the various fields may be input using a keyboard 270, which may be implemented using a touch screen in the embodiments in which the device is an iPad (FIG. 2C). The user interface 200 also includes a list 260 of questions with checkable answers “Yes” and “No” for allowing the user of the device 10 to complete the questions based on responses from the patient. This allows healthcare professional to intake medical history of the patient or update the history. The user interface 200 further includes a field 262 for allowing the user of the device 10 who is doing the screening to enter his/her name, and a field 264 for allowing the date of the screening to be entered. The user interface 200 also includes a field 266 for allowing another user to verify the screening, and a field 268 for allowing the date of the verification to be entered.

In some embodiments, after the various inputs have been entered using the user interface 200, the processor 16 of the device 10 then processes the information, and causes the information to be transmitted from the device 10 to the database 14 for storage at the database 14. The stored information may then be retrieved later (e.g., by the user of the device 10, and/or by another user of another device 10, etc.). In some embodiments, the database 14 may be at a secure location, and the patient information may be imported/downloaded from the secure location.

In some embodiments, the device 10 may also provide a messaging functionality for the user of the device 10. For example, in some embodiments, the user interface 200 may allow a pop up frame (message field) 280 to be displayed, so that the user of the device 10 may type a message (e.g., using the keyboard 270), and may send the message to another person (FIG. 2D). In some embodiments, the message field 280 may be brought up by the user of the device 10 (e.g., by selecting an icon displayed on the screen 202) any time, regardless of which of the tabs 220 that the user has been selected.

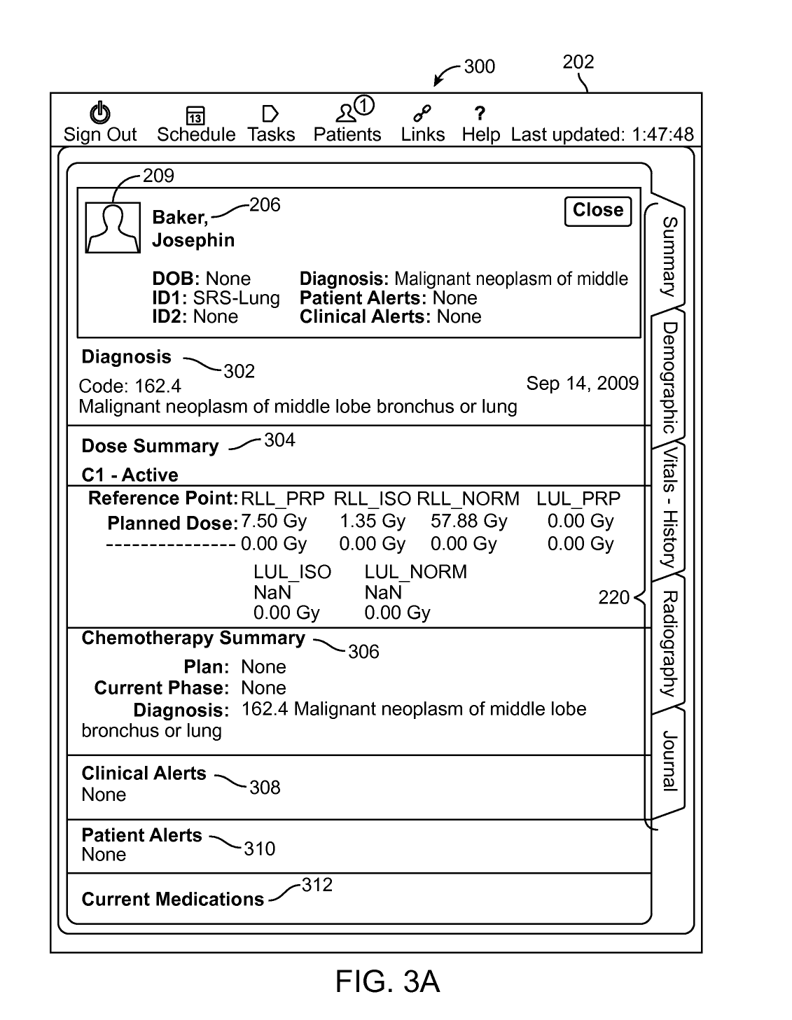

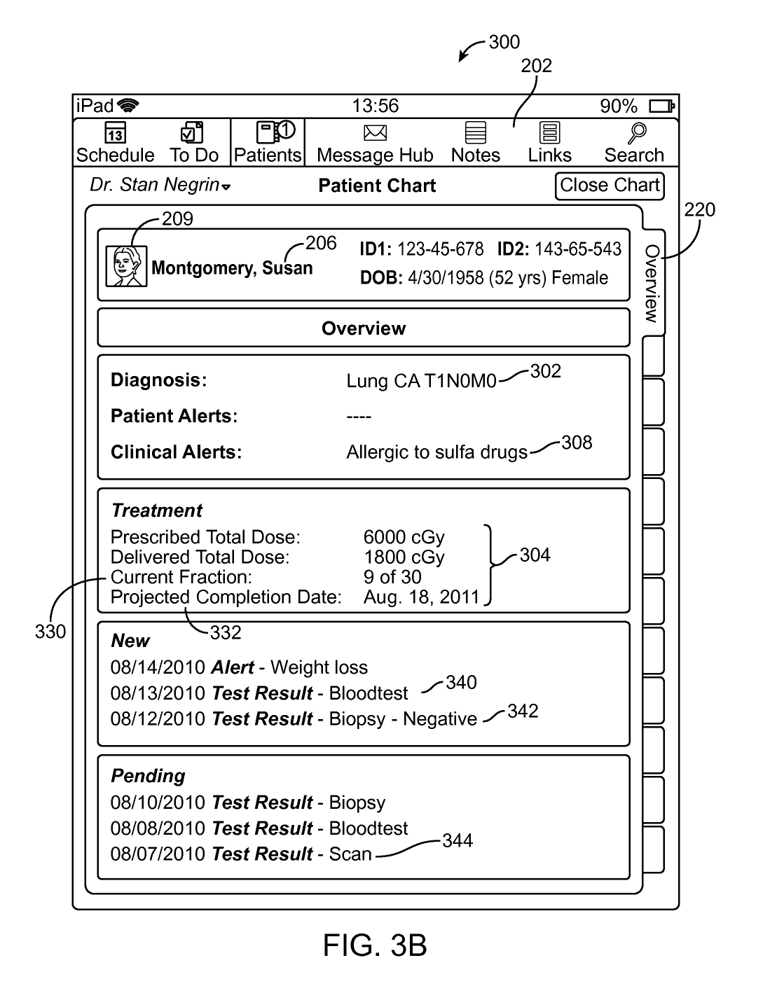

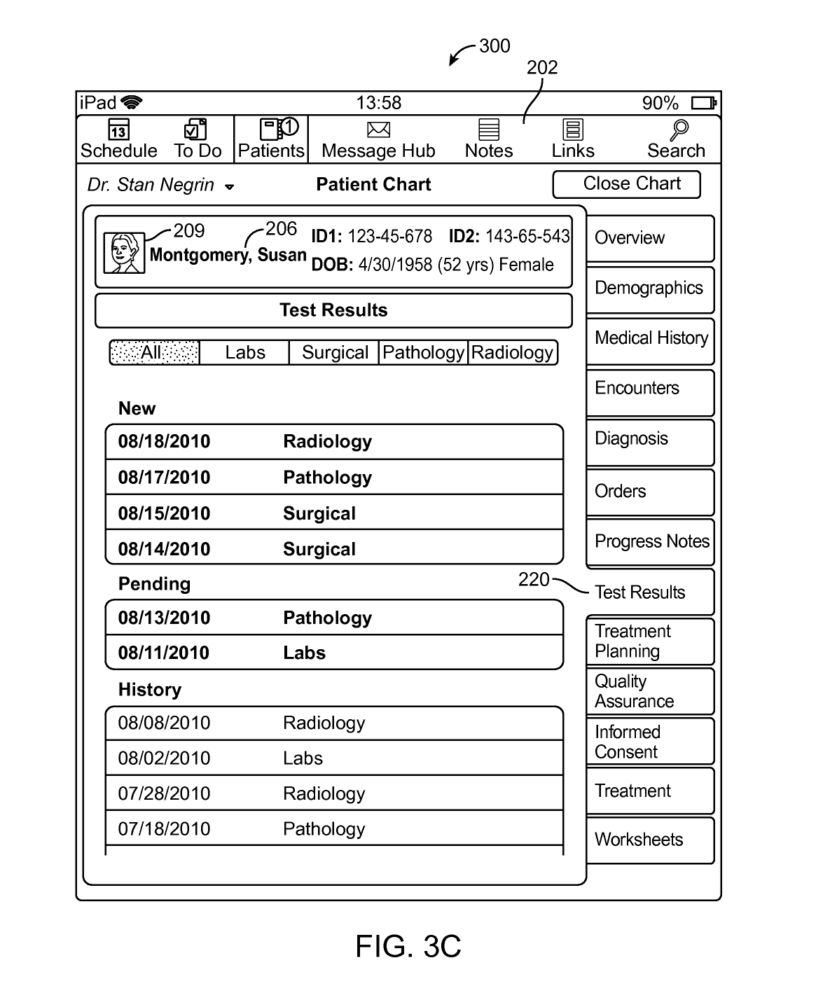

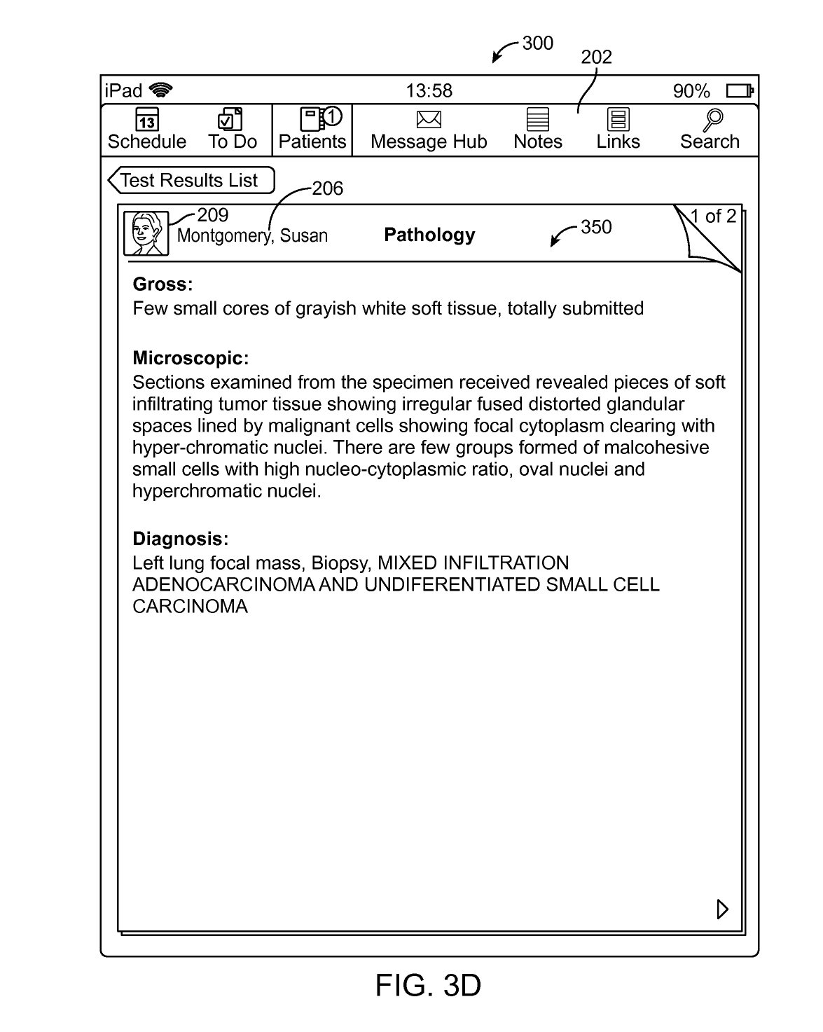

In some embodiments, the device 10 may be used to retrieve and display information regarding a patient. FIG. 3A illustrates a user interface 300 displayed in the screen 202 for presenting medical information regarding a patient in accordance with some embodiments. The user interface 300 includes the plurality of tabs 220. In the illustrated embodiments, the tab 220 for “Summary” is selected, thereby causing patient summary to be displayed in the screen 202 of the device 10. In the example shown, the patient summary includes diagnosis information 302, dose summary 304, chemotherapy summary 306, clinical alerts 308, patient alerts 310, and information regarding current medications 312. The diagnosis information 302 includes a diagnosis of the patient. The dose summary 304 includes information regarding reference points, planned dose, and delivered dose. The chemotherapy summary 306 includes information regarding a chemotherapy plan, a current phase of the chemotherapy, and a diagnosis of the medical condition to which the chemotherapy is designed to treat. The clinical alerts 308 alert the medical professionals certain medical condition of the patient. For example, if the patient is allergic to certain medication, such information would be provided under the clinical alerts 308. The patient alerts 310 alert certain medical condition of the patient. For example, if the patient has lost a significant amount of weight, then such information would be provided under patient alerts 310. The current medications 312 provides a list of medicine which has been prescribed for the patient.

One or more of the information provided in the user interface 300 may be retrieved by the database 14 in response to a request transmitted from the device 10. The database 14 then transmits the retrieved information and sends the information to the device 10 for display on the screen 202.

In some embodiments, one or more of the information shown in the user interface 300 may be selectable. For example, in some embodiments, a user of the device 10 may select the information under diagnosis 302. In such cases, the user interface 300 may display further information regarding the diagnosis 302.

It should be noted that the patient summary should not be limited to the example described, and that the patient summary may provide other information. For example, in other embodiments, the user interface 300 may provide information regarding current fraction 330 of a radiotherapy for a patient and projected completion date 332 of the radiotherapy (FIG. 3B). Also, as shown in FIG. 3B, in some embodiments, the user interface 300 may provide blood test result 340, biopsy result 342, and scan result 344. One or more of the information provided in the user interface 300 may be retrieved by the database 14 in response to a request transmitted from the device 10. The database 14 then transmits the retrieved information and sends the information to the device 10 for display on the screen 202. In some embodiments, one or more of the information shown in the user interface 300 may be selectable. For example, in some embodiments, a user of the device 10 may select a “Test Result” displayed on the screen 202. In such cases, the user interface 300 may display a test results page (FIG. 3C), showing information regarding different test results (such as test results from a lab, test results from surgical department, test results from pathology, test results from radiology, etc.). The user interface 300 may also display the dates that correspond with the respective test results. In the illustrated embodiments, the “test result” page is associated with one of the tabs 220 that is labeled “Test Results”. That means the user may optionally access this page by selecting the tab 220 for the “Test Results” or by selecting the “Test Result” test in the display page shown in FIG. 3B. In other embodiments, the “Test Results” page is accessed as a sub-page. In such cases, there will be no tab 220 for the “Test Results”, and the user can access such page as a sub-page under one of the tabs 220 (e.g., the “Patient Summary” tab 220 in FIG. 3A).

In some embodiments, detail information regarding one of the tests may be retrieved by selecting one of the test results (e.g., the test results shown in FIG. 3B, or FIG. 3C). When the user selects one of the test results, the device 10 sends a request to the database 14 in response to the selection. The database 14 receives the request, and retrieves the requested test result from its medium. The database 14 then transmits the test result information to the device 10 for display on the screen 202. FIG. 3D illustrates an example of a pathology test result 350 that may be displayed on the screen 202 of the device 10. In some embodiments, if the device 10 is being used by a doctor, the doctor may adjust a treatment plan based on the information he/she sees in the pathology test result 350. For example, in some embodiments, the device 10 may provide a user interface for allowing a doctor to make changes to a treatment plan. Such feature will be described in further detail below.

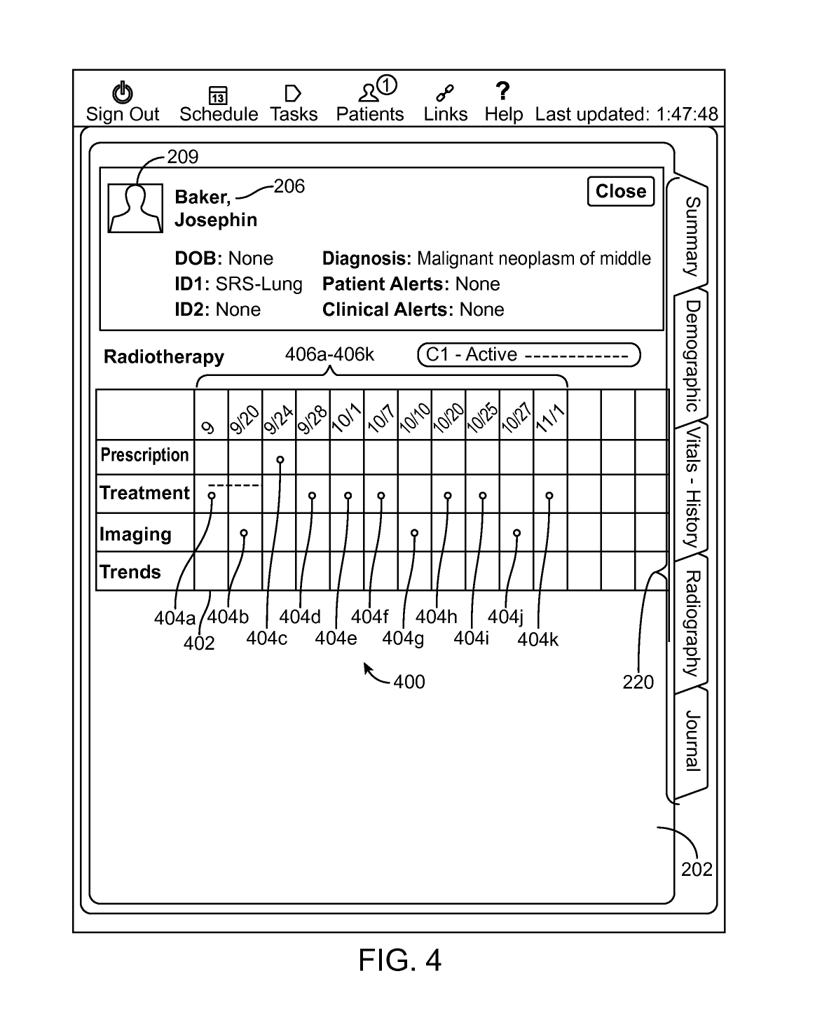

In other embodiments, the user interface may provide “Radiotherapy” as one of the tabs 220. FIG. 4 illustrates a user interface 400 that provides a “Radiotherapy” tab 220. When the user of the device 10 selects such tab 220, the device displays the information shown in the figure. In the illustrated embodiments, the user interface 400 provides a graph 402 that indicates different tasks 404a-404k of a treatment process for a patient at different respective dates 406a-406k. As shown in the figure, the tasks 404a-404k of the treatment process are arranged in a time line. This allows a user of the device 10 to see which task(s) has been completed and which task(s) is pending, as well as their temporal relationship with respect to each other. In the illustrated embodiments, tasks 404a-404g are represented as solid dots, indicating that the tasks 404a-404g have been completed. Tasks 404h-404k are pending, and are therefore represented by different graphics (e.g., open dots). When a task 404 has been completed, and has been signed off, then the database 14 will store the completed task 404 and its associated status “completed” in its medium. During use, when the device 10 requests for a radiotherapy summary from the database 14, the database 14 then retrieves the tasks of the radiotherapy, their respective dates, and their respective status (e.g., pending, completed, etc.), and transmits these information to the device 10 for display in the graph 402.

In some embodiments, any of the tasks 404a-404k may be selected by the user of the device 10. For example, in some embodiments, when the task 404c is selected, the user interface 400 then displays additional information (e.g., more detailed information) regarding the selected task 404c. In some embodiments, such additional information may be retrieved from a medium by the database 14, which transmits such information to the device 10 for display on the screen 202.

In the illustrated embodiments, the different tasks 404a-404k are organized in different categories, “Prescription”, “Treatment”, “Imaging”, “Trends”. The tasks under the “Prescription” category are prescription-related tasks, such as dose prescription, etc. The tasks under the “Treatment” category are treatment-related tasks, such as treatment planning, patient setup, treatment execution to deliver radiation dose, etc. The tasks under the “Imaging” category are imaging-related tasks, such as x-ray procedure(s), CT procedure(s), PET-CT procedure(s), imaging processing procedure(s), target segmentations, etc. These tasks may be considered to be part of the overall treatment process because imaging may be needed for the treatment process (e.g., for identifying target(s), treatment planning, patient setup, target position verification, dose verification, etc.). The tasks under “Trends” are tasks for capturing trends, such as changes in the source-to-skin distances, patient weight, etc., over time. For example, a patient, while on treatment, may lose weight. The weight loss is gradual but by trending it, the user can determine if any intervention is required before the patient loses too much weight. The same goes for source-to-skin distances. If the source-to-skin distances change too much from what was planned, intervention may be required. Trending data that are involved in a treatment process allows the user to be proactive in the intervention. In other embodiments, the graph 402 may not provide the tasks 404a-404k under different categories. Instead, each task 404 may have a description that describes the nature of the task. Also, in other embodiments, each task 404 may be represented by a text box that includes different information, such as task description, person assigned to perform the task, location of the task, etc.

The chart 402 displaying various tasks 404 for a treatment process for a patient is beneficial because it allows different professionals (e.g., doctors, imaging technicians, nurses, etc.) who participate in the treatment process to conveniently see how the different tasks are related to each other. For example, the person responsible for task 404h will see from the chart 402 that the previous task 404g has been completed, and therefore the task 404h is a pending task that needs to be completed before the next task 404i can begin.

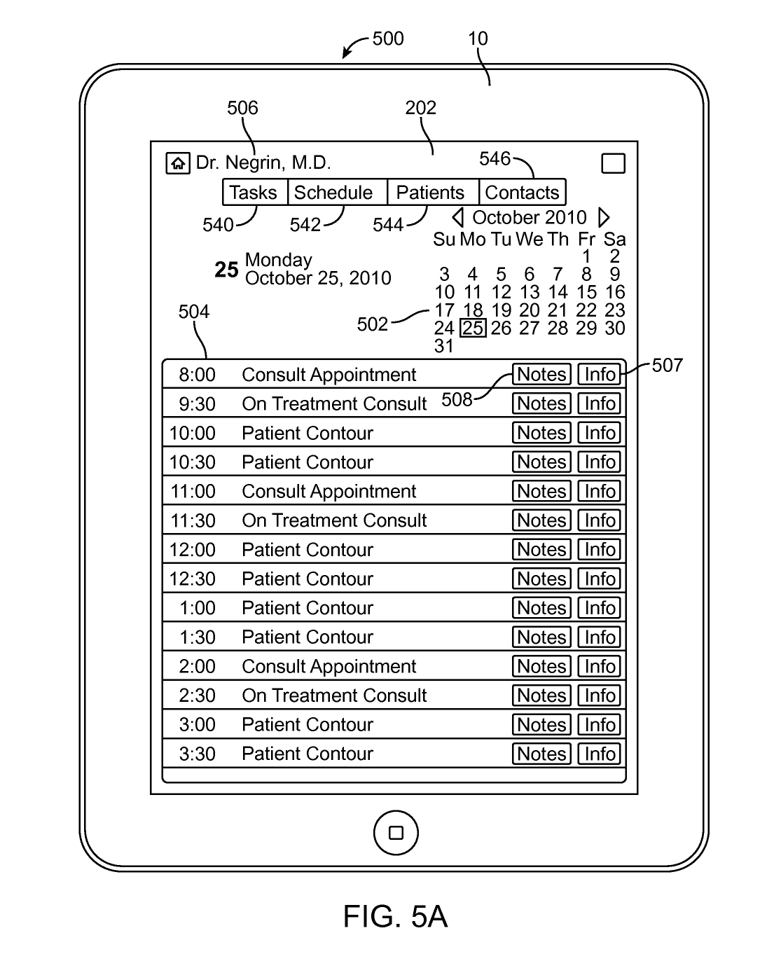

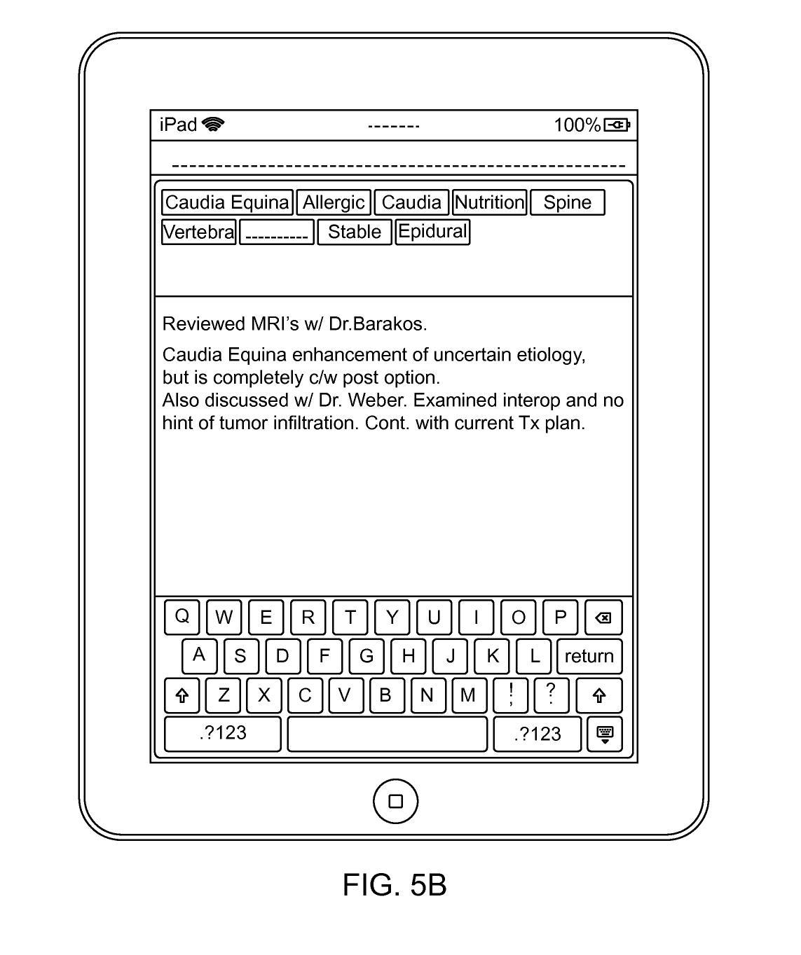

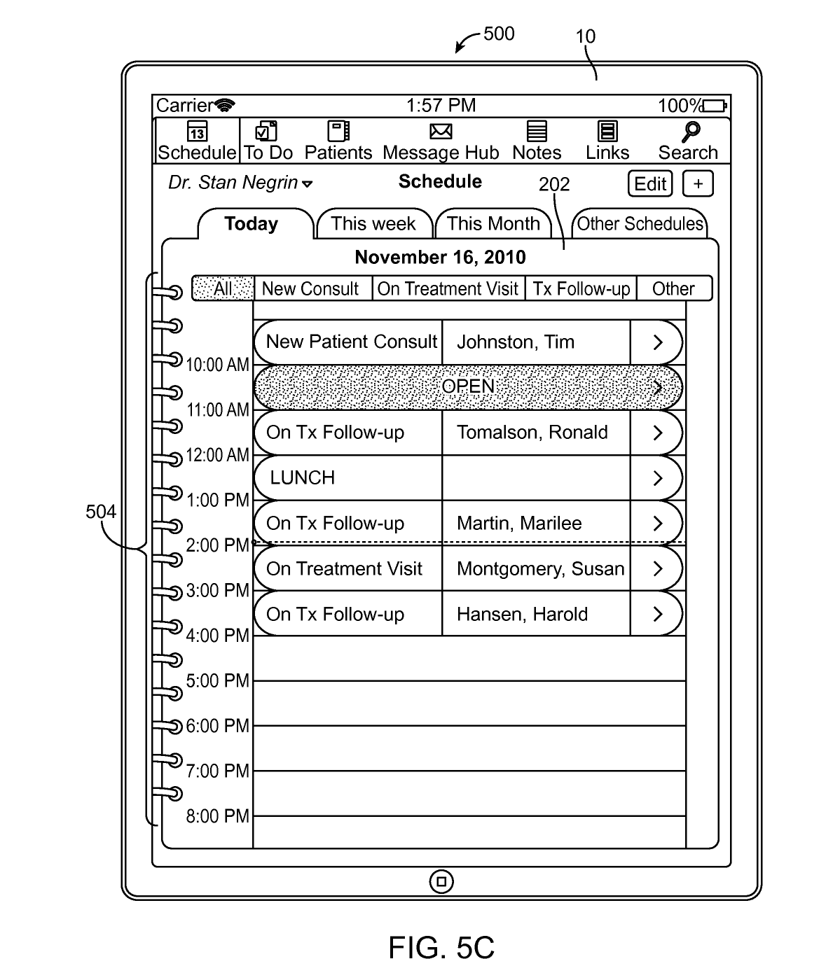

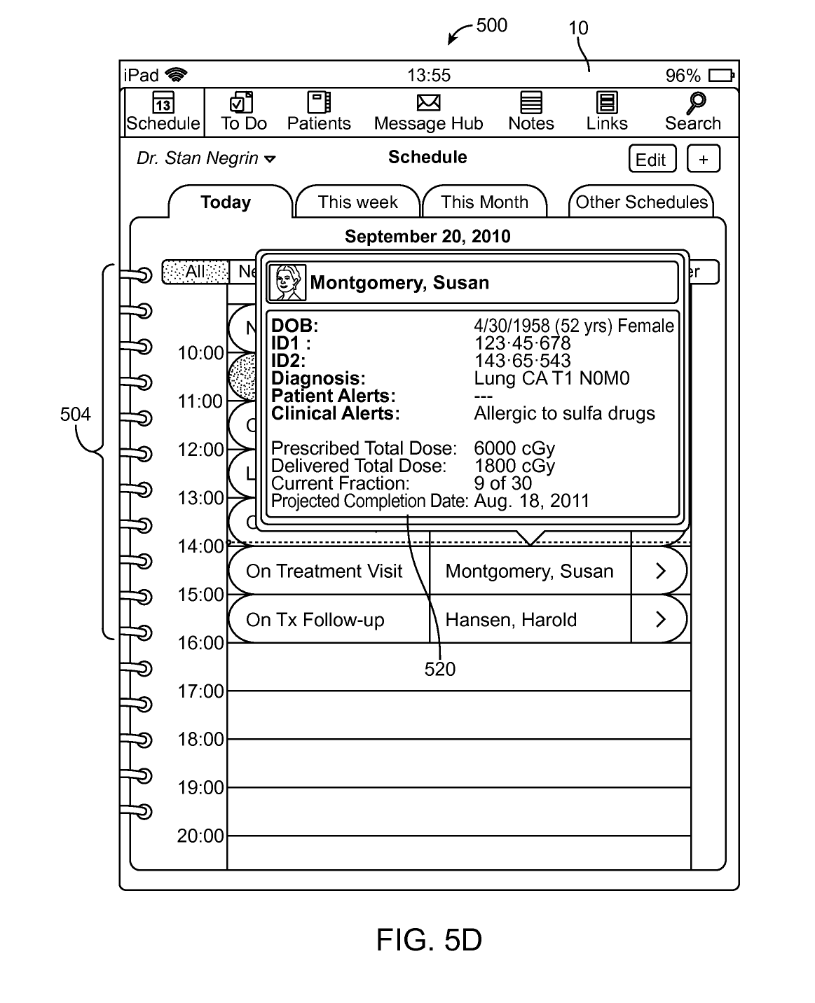

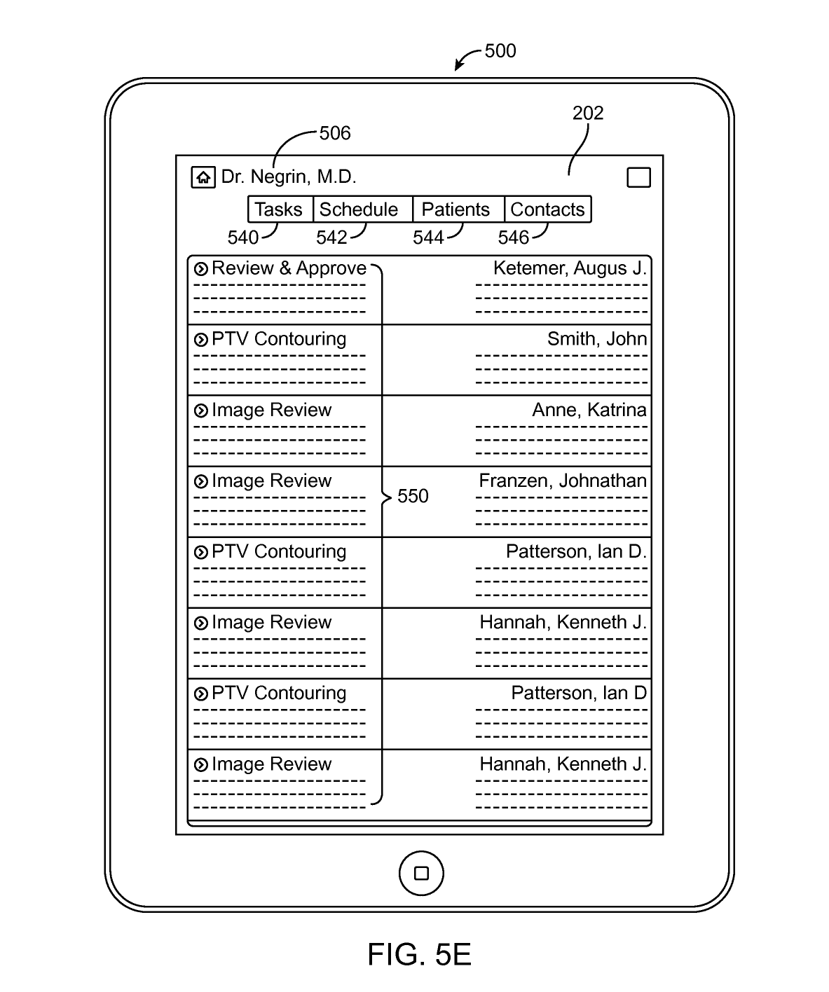

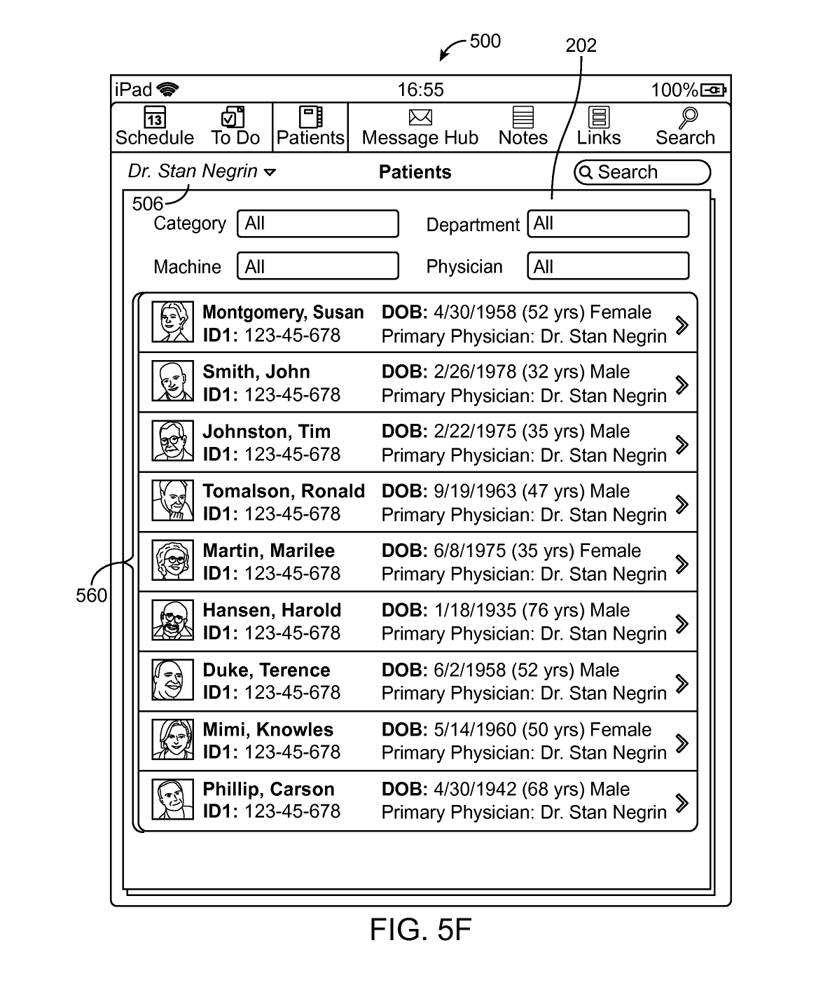

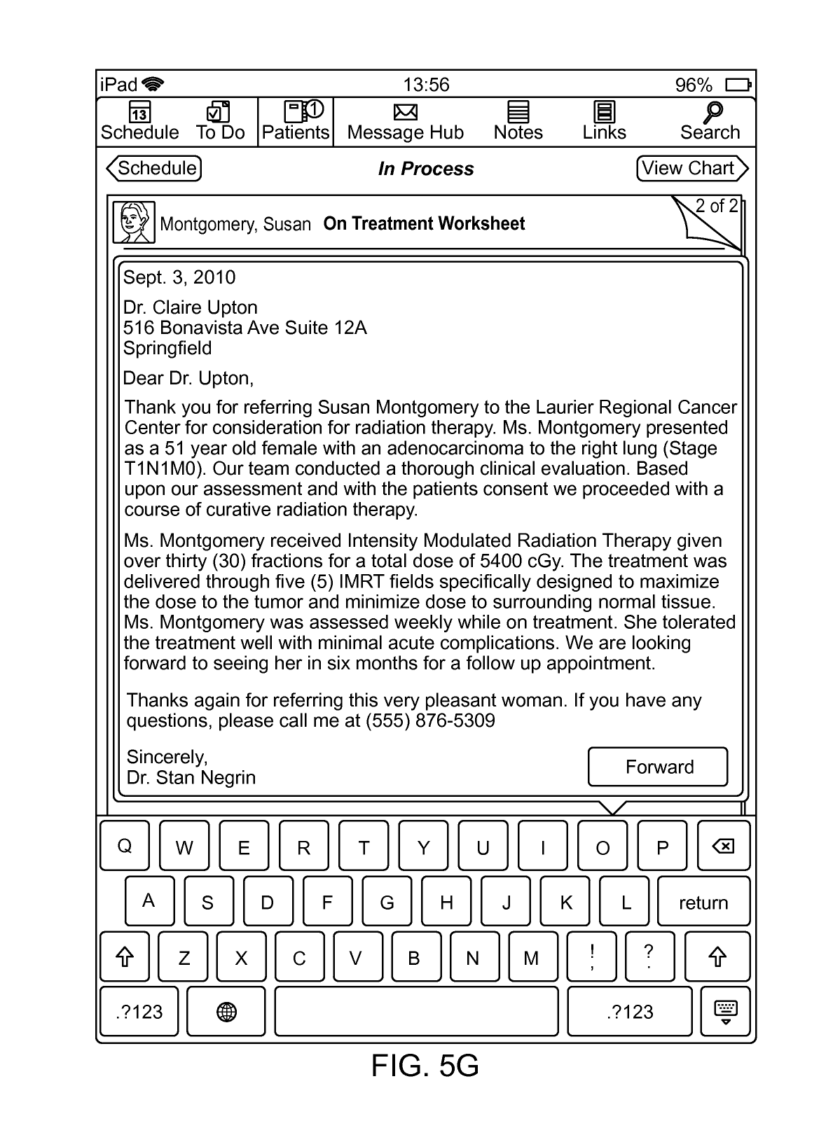

In some embodiments, the user interface may provide a “scheduling” tab, which allows a user of the device 10 to look up scheduling information, and/or to perform scheduling tasks. FIG. 5A illustrates a user interface 500 for presenting scheduling information in accordance with some embodiments. The user interface 500 includes a calendar 502 with dates that are individually selectable. The user interface 500 also includes a list 504 of activities that have been scheduled for a particular user 506 (e.g., a nurse, a doctor, etc.) in a particular day (which is October 25 in the example shown) selected from the calendar 502. The user interface 500 allows the user to see different activities that have been scheduled in different dates. Each activity in the list 504 may be selectable (e.g., using the “Info” button 507) for allowing the user to see additional information regarding the activity. Also, the user of the device 10 may select the “Notes” button 508 for entering notes for different activities in the list 504. For examples, in some embodiments, when the button 508 is selected, the user interface 500 provides a text field and a keyboard for allowing a user of the device 10 to enter notes for a certain task 504 (FIG. 5B).

In some embodiments, the activities in the list 504 (as well as their associated information, such as dates, detail information regarding the activities, notes, etc.) may be stored in the database 14. In such cases, when the user of the device accesses the scheduling tab 220 at the device 10, the device 10 then transmits a request to the database 14. The database 14 retrieves the scheduling information from its medium, and transmits the retrieved scheduling information to the device 10 for display on the screen 202.

Also, in some embodiments, the user of the device 10 may change an activity displayed in the list 504 using the device 10. For example, in some embodiments, the user may delete an activity in the list 504, enter a new activity in the list 504, or move an activity in the list 504 from one time slot to another. After the user has used the device 10 to make change to the list 504, the device 10 then transmits the information regarding the change to the database 14. The database 14 then updates the list of activities stored in its medium based on the change made by the user. In some embodiments, the updates may be automatically propagated to one or more devices 10. In other embodiments, the updates may be propagated to a device 10 in response to a user of the device 10 executing certain application, or in response to a user logging into the database 14 using the device 10. In further embodiments, the updates may be sent from the database 14 in response to a user of the device 10 requesting for the scheduling information. For example, when the user of the device 10 requests for the scheduling information, the database 14 will retrieve the updated list of activities, and transmits the information to the device 10 for display on the screen 202.

In some embodiments, the user interface may be configured to allow certain tasks be performed based on a level of authorization for a user of the device 10. For example, in some embodiments, a nurse and a doctor may have different levels of authorization. In such cases, the user interface may be configured to allow certain tasks/changes be made by a doctor (and not by a nurse). Also, the user interface may be configured to allow certain tasks/changes be made by both a doctor and a nurse, and other tasks/changes be made only by a nurse (and not by a doctor). This feature may also be applied for other input fields in the user interface. For example, in some embodiments, the user interface may be configured to allow certain input field(s) be used by a doctor (and not by a nurse). Also, the user interface may be configured to allow certain input field(s) be used by both a doctor and a nurse, and other input field(s) be used only by a nurse (and not by a doctor).

It should be noted that the configuration of the scheduling tab is not limited to the example described, and that the scheduling tab may have different configurations in different embodiments. FIG. 5C illustrates a variation of the scheduling tab for the user interface 500 in accordance with other embodiments. The user interface 500 includes a list 504 of activities that have been scheduled for a particular user 506 (e.g., a nurse, a doctor, etc.) in a particular day (which is Nov. 16, 2010 in the example shown). The user of the device 10 may optionally view activities in a week, or in a month, by selecting the “This Week” tab or the “This Month” tab above. In some embodiments, each item in the list 504 may be selectable, in which case, when the user selects the item, the user interface 500 will display further information regarding the selected item. FIG. 5D illustrates an example in which the item for “Montgomery, Susan” is selected. When this happens, the device 10 sends a request to the database 14, which then retrieves additional information regarding the selected item. The database 14 then transmits the retrieved information to the device 10 for display on the screen 202. In the illustrated example, the additional information is displayed in a frame 520, which includes a patient name, date of birth, diagnosis for the patient, patient alerts, clinical alerts, prescribed dose information, delivered dose information, current fraction information, and projected completion date of the radiotherapy.

In other embodiments, instead of accessing the scheduling page using a tab 220, the scheduling information may be accessed as a sub-page. For example, as shown in FIG. 5E, in other embodiments, the user interface 500 may provide a page for allowing a user of the device 10 to select a “Schedule” button 542. When such button 542 is selected, the user interface 500 may then display a scheduling page (such as the example shown in FIG. 5A or 5C). As shown FIG. 5E, the user interface 500 may also include other buttons, such as the “Tasks” button 520, the “Patients” button 544, and the “Contacts” button 546. When the “Tasks” button 520 is selected, the user interface 500 displays a list 550 of tasks that have been scheduled for the particular user 506. When the “Patients” button 544 is selected, the user interface 500 then displays a list 560 of patients who are being treated by the particular user 506 (FIG. 5F). When the “Contacts” button 546 is selected, the user interface 500 then displays a list of contacts on the screen 202. In some embodiments, the user of the device 10 may select one of the contacts on the screen 202, and send a message (e.g., an email) to the selected contact.

Returning to FIG. 5A and FIG. 5E, the user interface 500 includes a contact button 546, which allows a user of the device 10 to send correspondence to another person. For example, in some embodiments, the user may be a doctor, who is performing certain task(s) 504/550. The doctor, while or after performing the task(s), may want to send a correspondence to a colleague. The doctor may then select the button 546, in which cases, the user interface 500 may provide a text field and a keyboard for allowing the user to type and send a message (FIG. 5G).

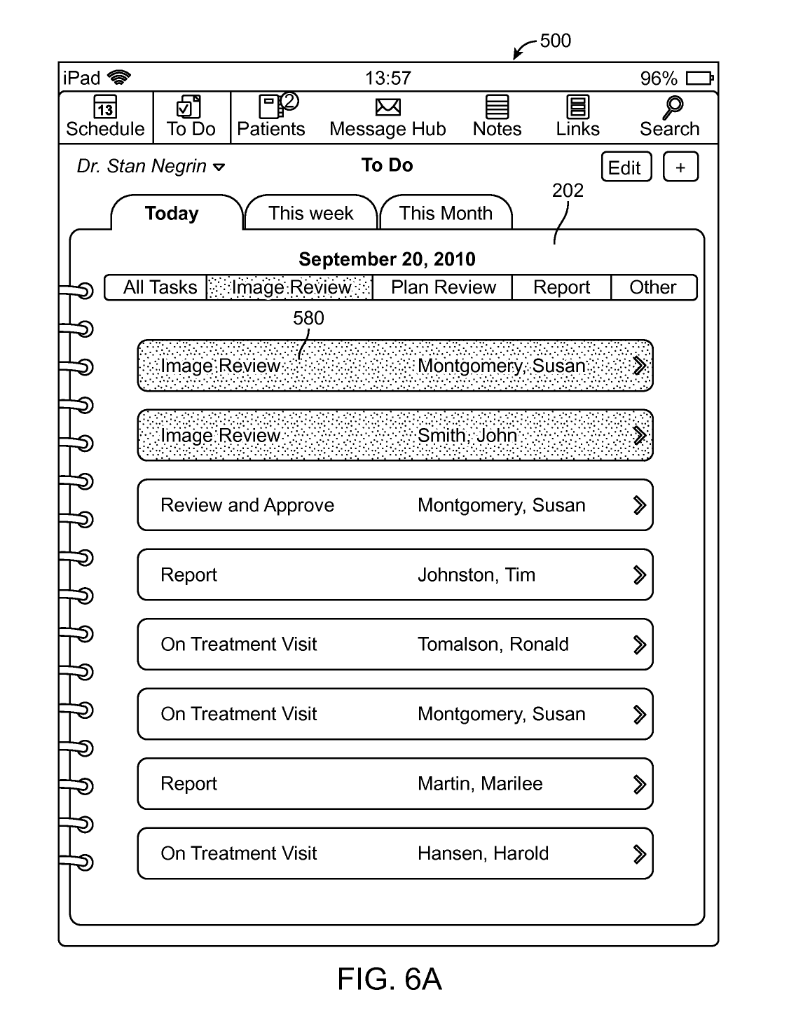

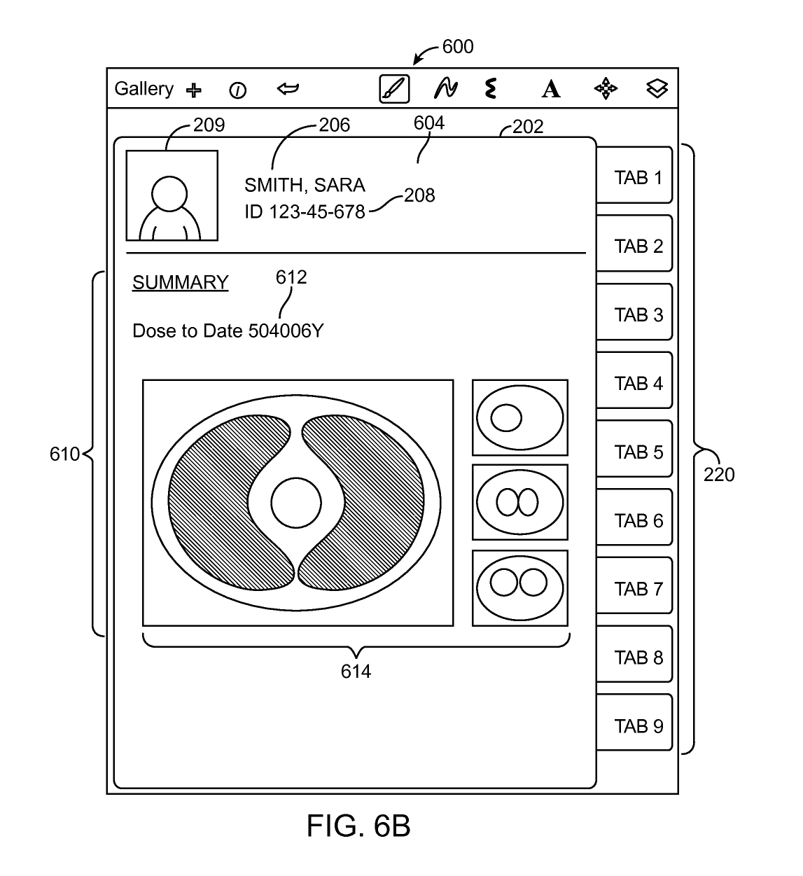

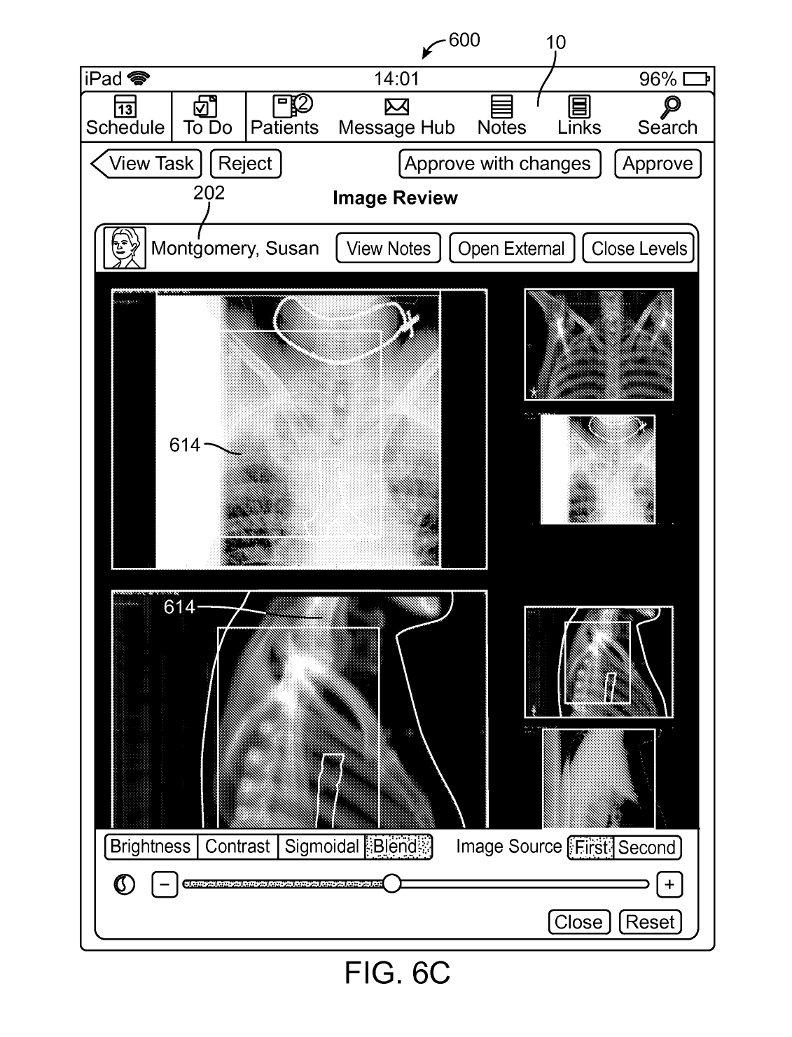

In other embodiments, the device 10 may provide a user interface for allowing a user of the device 10 to view medical images for a patient. For example, as shown in FIG. 6A, the device 10 may display a user interface 500 for presenting scheduling information on the screen 202. The scheduling information includes various activities assigned for a given user on a certain day. The user interface 500 is similar to that discussed with reference to FIG. 5. As shown in the example, the list of activities assigned may include an image review task 580. During use, the user may select the image review task 580 in the schedule page. Alternatively, the user may select one of the tabs 220 for retrieving medical images. In response to the user's selection, the device 10 sends a request to the database 14 to request for image information. The database 14 retrieves the image information from its medium, and sends the image information to the device 10. The processor in the device 10 processes the image information, and displays images using the image information on the screen 202. As shown in FIG. 6B, the device 10 may display a user interface 600 for presenting the images. The user interface 600 includes a display area 604 for displaying the name 206 of a patient, a patient identification 208, the picture 209 of the patient, and medical information 610 for the patient. In the illustrated example, the medical information 610 includes a dose summary 612 for the patient, and anatomical images 614 (e.g., x-rays, CT images, PET images, SPECT images, PET-CT images, MRI images, etc.) of the patient. In other examples, the medical information 610 may include other types of information. FIG. 6C illustrates another example of the user interface 600, which presents different medical images 614 of the patient. The user interface 600 may optionally include one or more controls for allowing a user of the device 10 to adjust a brightness of an image, to adjust a contrast of an image, to select one of a plurality of images from a set of available images, to zoom in or out of an image, and/or to move one or more images within the screen 202.

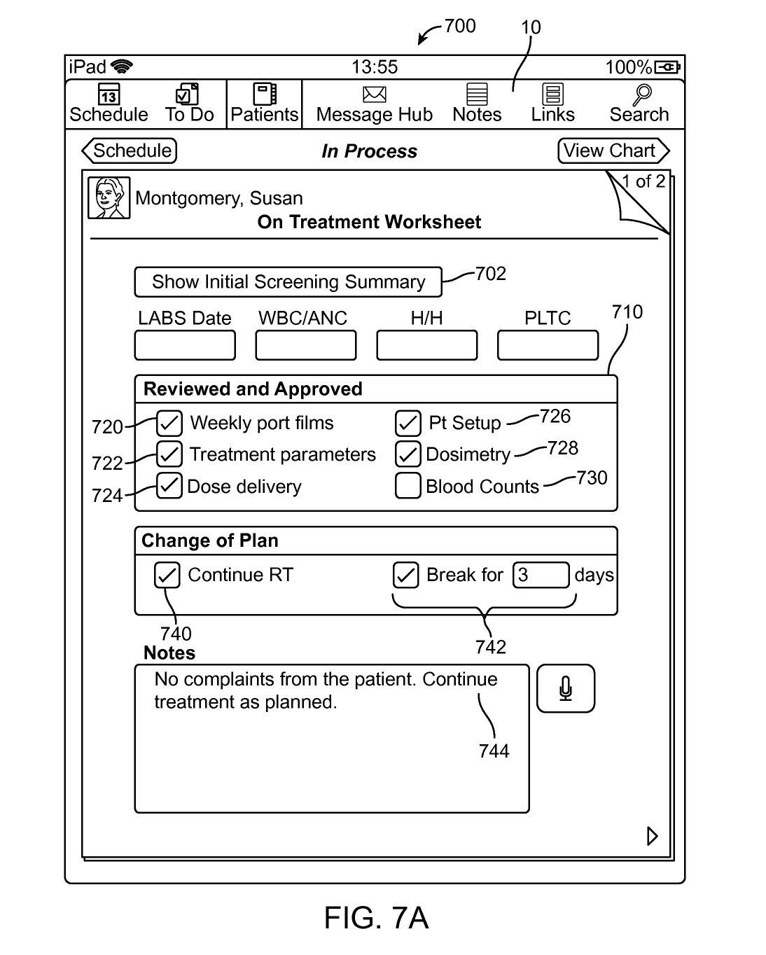

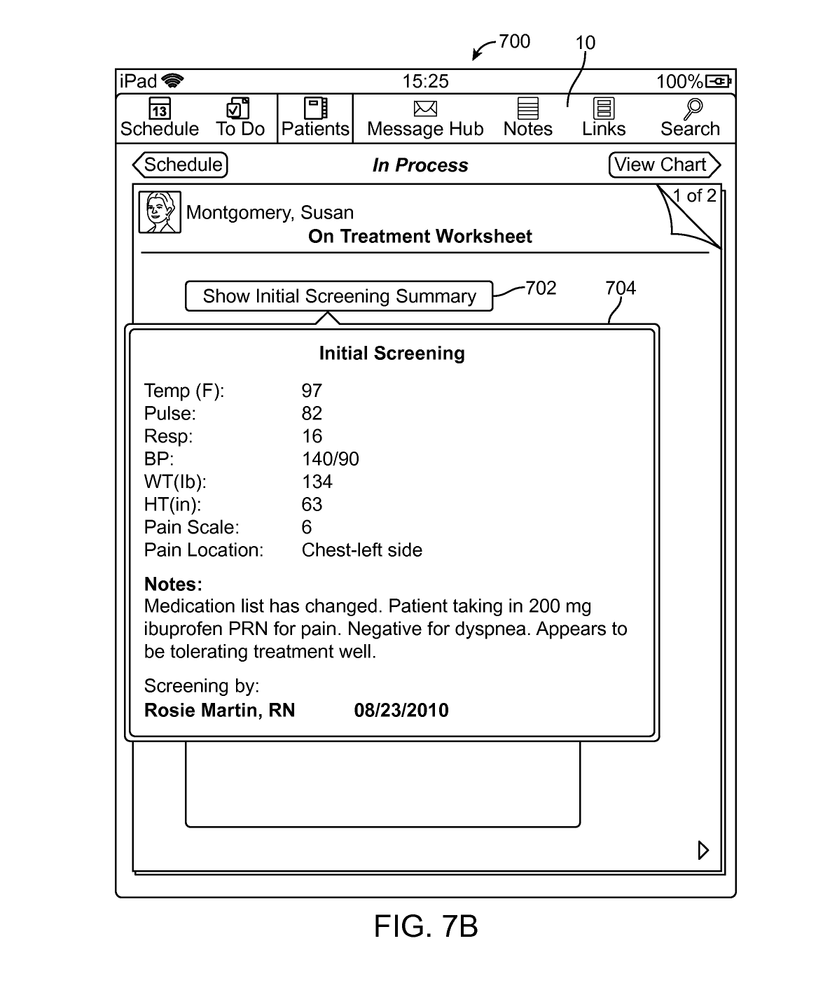

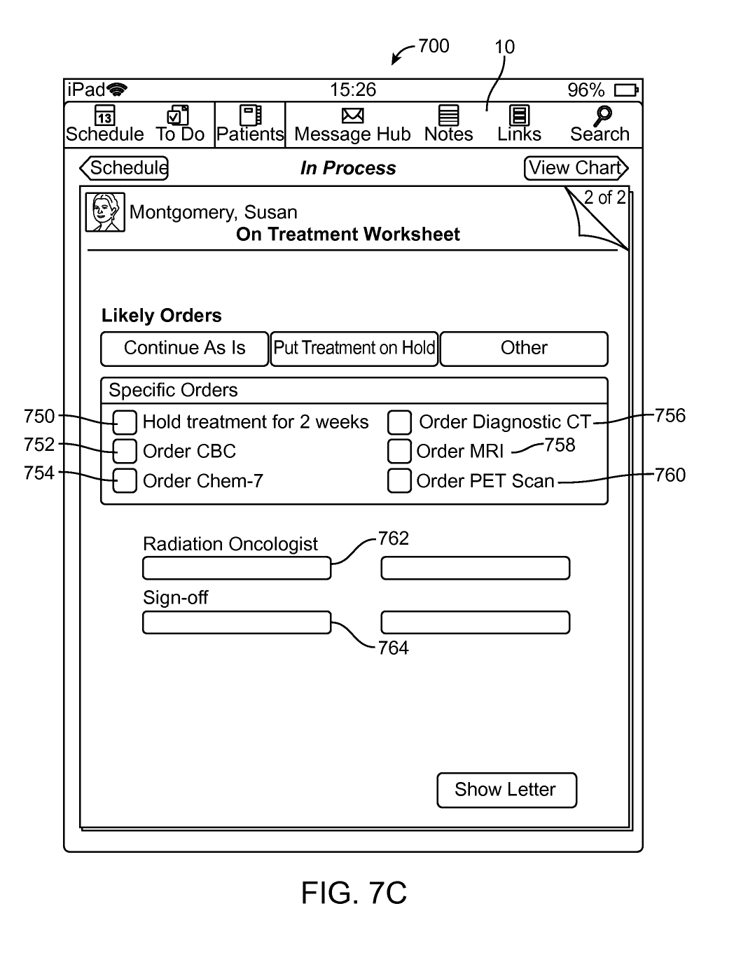

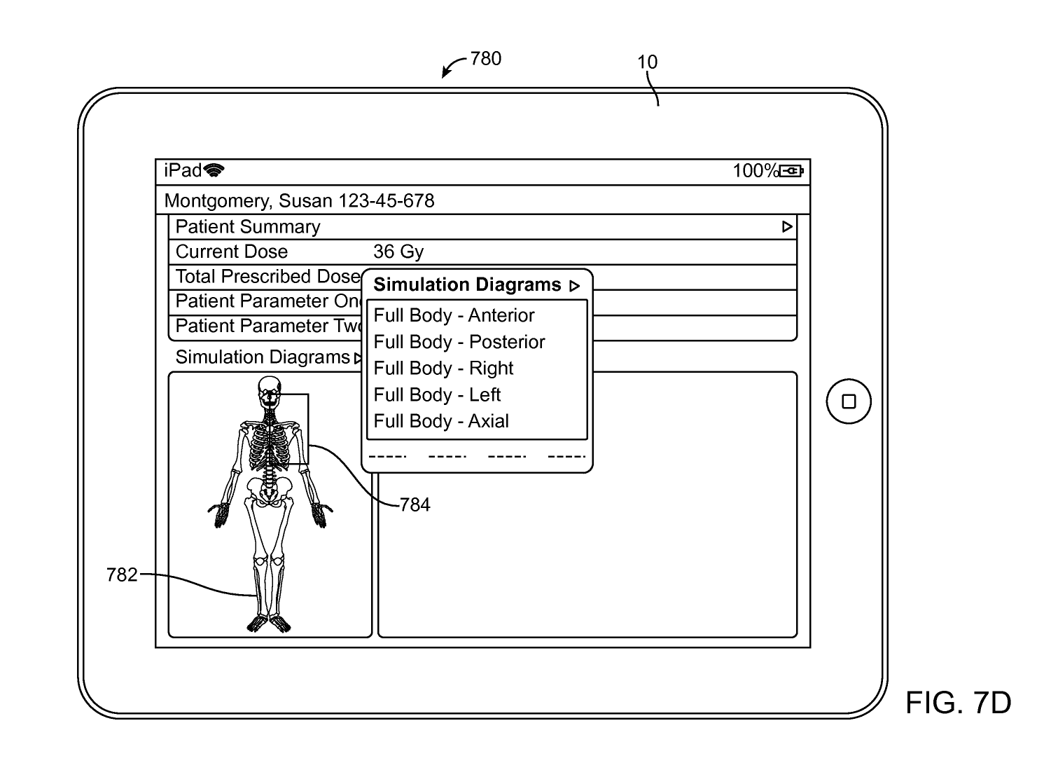

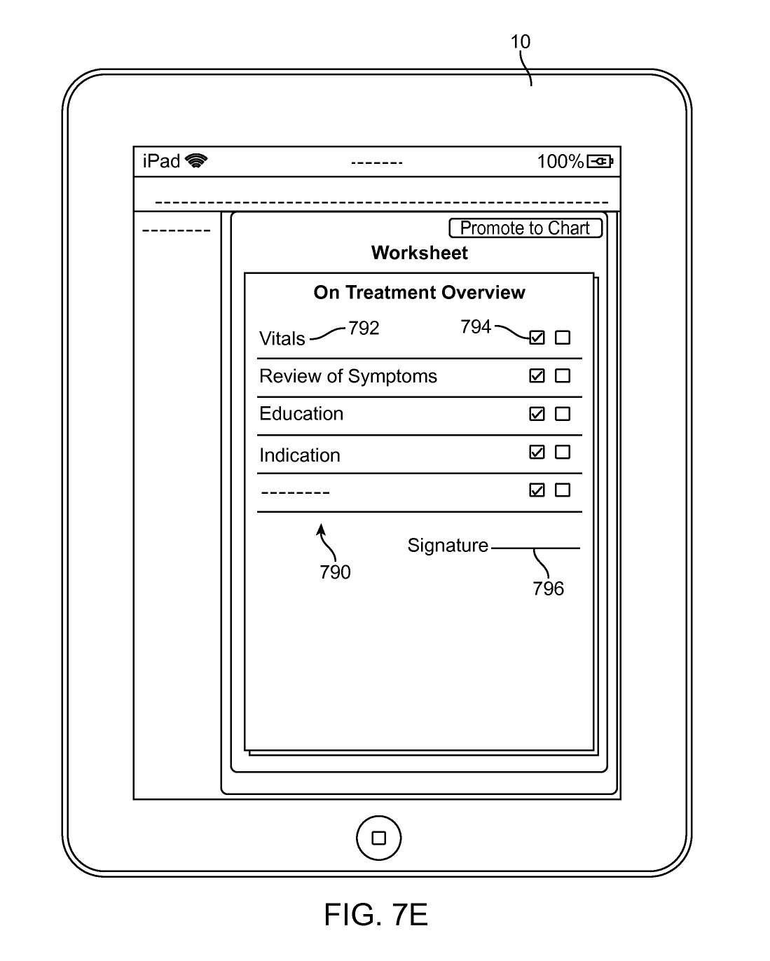

In other embodiments, the device 10 may provide a user interface for allowing different users to view and/or complete a treatment worksheet. FIG. 7A illustrates an examine of a user interface 700 displaying a treatment worksheet in accordance with some embodiments. The user interface 700 includes a button 702 for allowing a user to retrieve a screening summary. When the button 702 is selected by the user of the device 10, the device 10 sends a request to the database 14. In response to the request, the database 14 retrieves the screening summary stored in its medium, and transmits the retrieved screening summary 704 to the device 10 for display on the screen 202 (FIG. 7B).

Returning to FIG. 7A, the user interface 700 also includes a checklist 710 for allowing a user to see various items related to a treatment process. A checklist is a “to do” list for the user much like any checklist (e.g. airplane pilot pre-flight checklist). In some embodiments, the checklist 710 includes items that the user should check or do before delivering the treatment. In some cases, the checklist 710 may be considered a safety feature that provides a safety function. In the illustrated embodiments, the various items in the checklist 710 include weekly port films 720, treatment parameters 722, dose delivery 724, patient setup 726, dosimetry 728, and blood counts 730. Weekly port films 720 are films or images (e.g., x-ray images) taken through the actual treatment fields of the patient in treatment position. This is used to verify patient position as well as a record of where in the body the patient was treated. In some embodiments, if the port films have been received and/or processed, then the item for the weekly port films 720 may be checked off. Treatment parameters 722 include one or more machine settings that are required to deliver the patient's treatment. Examples of parameters include field size, gantry angle, collimator angle, couch angle, and accessories to modify the treatment beam. In some embodiments, if the treatment parameters have been determined, then the item for the treatment parameters 722 may be checked off. Dose delivery 724 includes dose delivery information. For examples, it may be an amount of dose to set the machine in order to deliver the treatment, dose energy, or combination of both, etc. In some embodiments, when dose delivery information have been obtained, then the item for the dose delivery 724 may be checked off. Patient setup 726 is for checking items involved in a setup. For examples, it may include confirming the position the patient is in for treatment delivery (e.g. lying on the back with the head towards the machine, etc.), checking items in set up instructions, etc. In some embodiments, a patient setup may involve using an immobilization device to keep the patient from moving. Dosimetry 728 may include any pre-treatment dose measurements that were taken to ensure that the correct dose is going to be delivered to the patient. It may also include treatment plan information, such as dose distributions and information about the doses the target and critical structures would receive. In some embodiments, when the dosimetry information has been obtained and/or confirmed, then the item for the dosimetry 728 may be checked off. Blood counts 730 may include hemoglobin, white cell, and platelet counts. If a patient is undergoing chemotherapy as well as radiation, his/her blood counts need to be closely monitored as these numbers may drop to dangerous levels. In addition, treating certain areas of the body with radiation alone can cause blood counts to drop. In some embodiments, when the blood count information has been obtained and/or confirmed that it is at acceptable level(s), then the item for blood counts 730 may be checked off.

The user interface 700 also includes a checkbox for “Continue RT” 740. When the user checks the box 740, that means the radiotherapy is to be continued. The user interface 700 also includes a check box and a field 742 for allowing a user (e.g., a doctor) to prescribe how many days to break before the treatment is to be continued. As shown in the figure, the user interface 700 further includes a field 744 for allowing a user to input and/or review notes regarding a treatment for a patient.

In some embodiments, the user interface 700 may also allow a user (e.g., a doctor) to make other orders. For example, as shown in FIG. 7C, in some embodiments, the user interface 700 may display a checkbox 750 for allowing a user to order a holding of treatment for a prescribed time (e.g., 2 weeks), a checkbox 752 for allowing a user to order a blood test to determine blood count, a checkbox 754 for allowing a user to order a chemotherapy, a checkbox 756 for allowing a user to order a diagnostic CT imaging, a checkbox 758 for allowing a user to order a MRI imaging, and a checkbox 760 for allowing a user to order a PET scan. In some embodiments, after an order has been completed (e.g., by checking one or more of the boxes 750-760), the device 10 may transmit the information regarding the order to the database 14 for storage. The database 14 stores the order information in its medium so that the information may be retrieved later (e.g., by the user of the device 10 or another device 10). Also, in some embodiments, the database 14 may be configured to automatically change one or more scheduling for one or more users based on the received order information. For example, if the user has prescribed that a CT imaging be performed (e.g., by checking box 756), the database 14 may then automatically insert an imaging task into a schedule of a CT technician. In some embodiments, certain field(s) in the user interface is allowed to be accessed only by user(s) with certain privilege(s). For example, in some embodiments, the box 756 is not allowed to be checked by a nurse, and is allowed to be checked only by a doctor. In some embodiments, the database 14 may automatically suggest a date for the imaging task, subjecting to the technician accepting the date. In other embodiments, instead of automatically inserting an imaging task into the CT technician's schedule, the database 14 may automatically sends a message to the CT technician, requesting the CT technician to enter a CT imaging task into his/her schedule. In the illustrated embodiments, the user interface 700 further includes a field 762 for allowing a user (e.g., a radiation oncologist) to enter his/her name, and a field 764 for allowing another user to sign off on the order.

In some embodiments, when a user of the device 10 orders for an imaging to be performed (e.g., by checking one of the boxes 756, 758, 760), the device 10 may present a user interface for allowing the user to select which part of the patient is to be imaged. FIG. 7D illustrates a user interface 780 for allowing a user of the device 10 to select a body part for imaging. The user interface 780 includes a diagram 782 of a patient, and a box 784. The box 784 is selectively moveable relative to the patient diagram 782 so that a user can select a certain body part of the patient using the box 784 for imaging. In some embodiments, the box 784 may also be made bigger or smaller. Furthermore, in some embodiments, the patient diagram 782 may be moved, turned, and/or scaled up/down (e.g., using the touch screen of the device 10 in the embodiments in which the device 10 is an iPad). In other embodiments, the user interface 780 may be used by a user of the device 10 to select which body part of the patient for treatment. For example, the box 784 may be dragged to the part of the patient diagram 782 where the liver is located, thereby prescribing a radiotherapy be performed on the liver.

In some embodiments, after a certain body part has been selected for imaging and/or treatment using the user interface 780, the device 10 then sends the prescription to the database 14 for storage. The database 14 may later retrieve the prescription information in response to a request by a user of the device 10 or another device 10, and may send the prescription information to the device 10 for display on the screen 202. Also, in some embodiments, the database 14 may automatically create or update a task (e.g., an imaging task and/or a treatment task) based on the prescription information. For example, in some embodiments, a previous imaging task for a CT technician may prescribe a certain region of a patient to be imaged. A doctor may decide to make the scanning region bigger using the user interface 780. In such cases, when the database 14 receives the prescription from the doctor, the database 14 may automatically update the previously assigned imaging task for the CT technician, so that when the CT technician performs the imaging task, the CT technician will have the updated requested information. Similar updates may be automatically performed by the database 14 to update one or more treatment tasks.

Also, in some embodiments, the user interface 700 may provide a treatment overview for allowing a user to sign off on certain completed tasks. FIG. 7E illustrates a worksheet 790 presented by the user interface 700 that includes different tasks 792. Each task 792 has a corresponding checkbox 794 which allows a user to check-off on a completed task. Once a task 792 has been selected by the user as “completed” (e.g., by checking the box 794), and the user signing off the task 792 has e-signed the signature block 796, the device 10 then sends the signed-off information to the database 14. The database 14, upon receiving the signed-off information, will automatically update certain task(s) in its medium to have a “completed” status.

In some embodiments, the device 10 may present different worksheets 790 for different users. For example, a user who is a nurse may receive a worksheet 790 with task items that are different from that for a user who is a doctor. In one implementation, before the user of the device 10 is allowed to access information from the database 14, the user may be required to input a login name and password using the device 10. The device 10 then transmits the entered login name and password to the database 14. The database 14 will verify the login name and password by looking up the stored name and corresponding password stored in its medium. Once the user has been verified, the database 14 then presents certain information to the user based on the user's profession. For example, with respect to the worksheet 790 in FIG. 7E, the database 14 may provide different task items in the worksheet 790 for display by the device 10, depending on whether the user is a nurse, a doctor, an imaging technician, etc.

It should be noted that the feature regarding the database 14 providing different information based on the user's profession is not limited to the display shown in FIG. 7E, and that such feature may be used to provide different information in different displays (such as any of the ones described previously with reference to FIGS. 2-6, or any of the ones described herein after). Such feature allows different users in different professions to have different level of access for information stored in the database 14. For example, a nurse may be allowed to view treatment information, but not to make prescription. As another example, an imaging technician may be allowed to perform image review, and input notes regarding the images being reviewed, but he/she is not allowed to enter notes regarding a treatment procedure.

In other embodiments, the device 10 may provide a user interface for presenting other types of medical information. For example, in other embodiments, the device 10 may provide information related to a chemotherapy for a patient, such as lab results showing blood count.

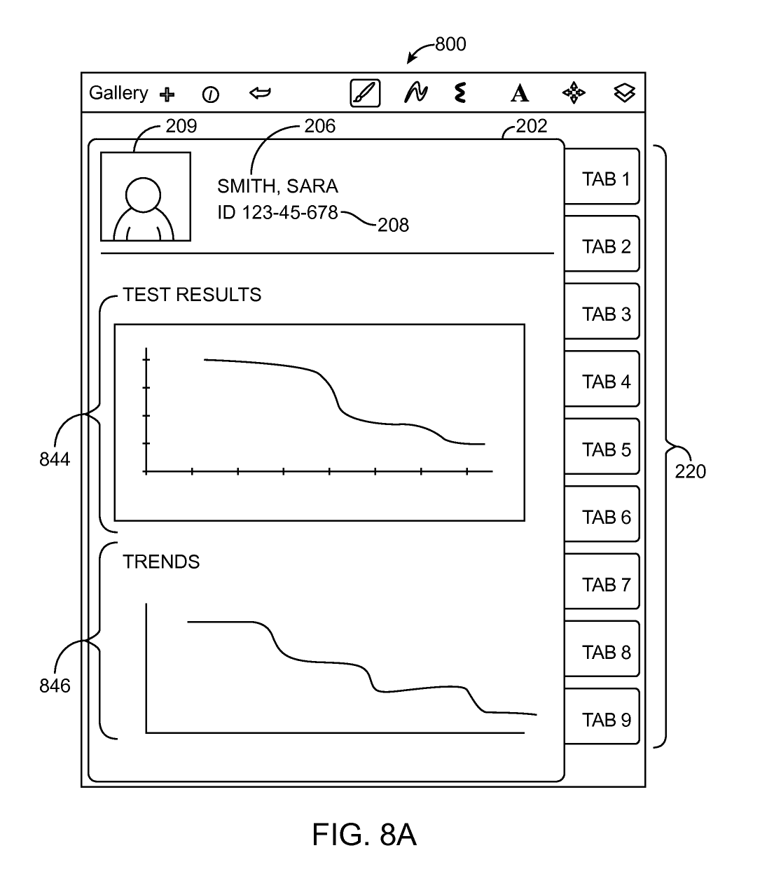

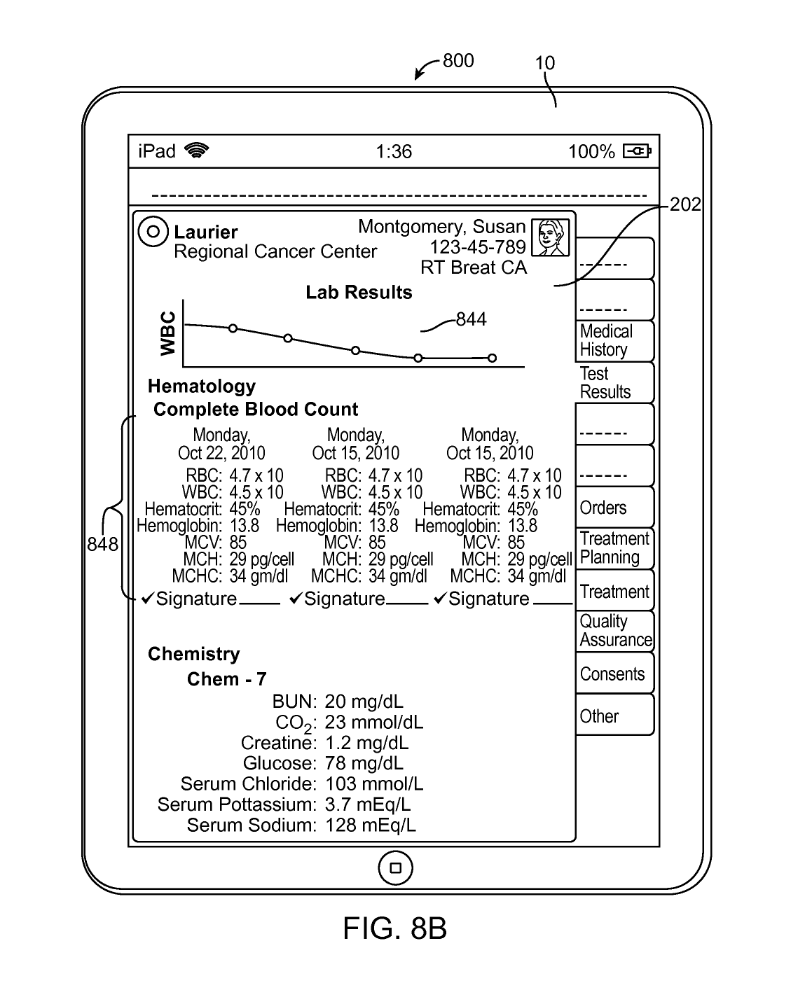

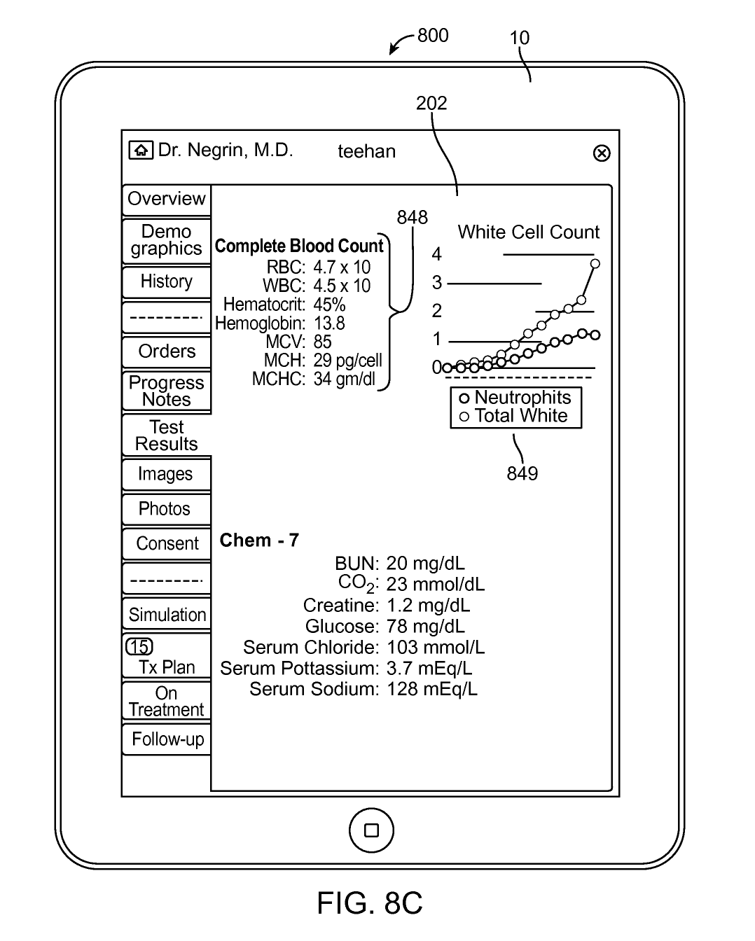

FIG. 8A illustrates another user interface 800 in accordance with some embodiments. The user interface 800 may be displayed on the screen 202 of the device 10 in response to a user selecting one of the tabs 220. The user interface 800 is configured for presenting lab results 844 to a user (e.g., a nurse, a doctor, etc.). In the illustrated example, the lab results 844 may include blood count information. In some cases, the lab results 844 may indicate that a white blood cell count is too low. In such cases, the user of the device 10 may use the device 10 to send an alert to a doctor (or the device 10/database 14 may be configured to automatically send an alert to a doctor). The doctor, upon receiving the alert, may then send an instruction to stop a treatment (e.g., chemotherapy treatment) for the patient. In some embodiments, the doctor may be using another device 10, which allows the doctor to send the instruction to stop the treatment by using an input at the device 10. As shown in the figure, the user interface 800 may also present a graph 846 showing a trend of lab results. For example, the graph 846 may show the white blood cell counts measured at different dates. In some embodiments, one or more of the information being presented at the user interface 800 may be transmitted from the database 14 to the device 10 in response to a request transmitted from the device 10 to the database 14 (wherein such request may be created by a user of the device 10 using an input device of the device 10).

FIG. 8B illustrates a variation of the user interface 800 for presenting lab results to a user. The user interface 800 includes a graph 844 showing the white blood cell count at different times. The user interface 800 also includes other blood count information 848. By means of non-limiting examples, the blood count information 848 may include red blood cell level, white blood cell level, hematocrit level, hemoglobin level, MCV, MCH, and MCHC. As shown in the figure, the blood count information 848 may be presented for different dates.

FIG. 8C illustrates a variation of the user interface 800 for presenting lab results to a user. The user interface 800 includes the blood count information 848. By means of non-limiting examples, the blood count information 248 may include red blood cell level, white blood cell level, hematocrit level, hemoglobin level, MCV, MCH, and MCHC. The user interface 800 also includes a chart 849 showing the level of neutrophils and total white cell count on different dates for the patient.

Although embodiments of user interfaces 200, 300, 400, 500, 600, 700, 800 have been described, it should be noted that two or more of these user interfaces may be parts of an overall user interface that is provided at the device 10. For examples, in some embodiments, all of the interfaces 200, 300, 400, 500, 600, 700, 800 may be provided at the device 10. Thus, as used in this specification, the term “user interface” may refer to one or more user interfaces.

In any of the embodiments describe herein, the user interface may be implemented using software, hardware (e.g., processor(s), such as the processor 16 within the device 10, the processor 56 at the database 14, or both), or combination of both. For example, in some embodiments, a computer product may be provided that includes instructions stored in a non-transitory medium, wherein an execution of the instructions by one or more processors (e.g., the processor 16 of the device 10, the processor 56 of the database 14, or both) causes a process to be performed. The process may involve providing any of the features of the user interface described herein, or any of the features described herein. In one implementation, one or more software may be stored in a non-transitory medium in the device 10. The device 10 may execute the software using the processor 16 to thereby process information received from the database 14, and to display the processed information in various page(s).

Also, in the above embodiments, various information presented at the device 10 has been described as being retrieved from the database 14. However, in other embodiments, some of the information may be stored in a non-transitory medium in the device 10. For example, in other embodiments, one or more pieces of data displayed in any of the user interfaces 200, 300, 400, 500, 600, 700, 800 may be stored in a non-transitory medium in the device 10.

As illustrated in the above embodiments, the system 2 is advantageous because it allows different professionals (e.g., nurses, doctors, imaging technicians, chemotherapists, etc.) participating in a treatment process to conveniently work on different tasks (e.g., by providing input using the device 10), view medical images, make changes to the treatment process (if needed), and correspond with each other. Because the same device 10 can allow a user to perform these tasks, it obvious the need for the user to use a dedicated station to perform one task, and then use another device to perform another task. Also, because the device 10 is mobile, the user can perform the tasks at any location. For example, when a doctor is visiting a patient in a hospital, the doctor may immediately enter notes using the device 10 based on his/her observation of the patient. The doctor may transmit the notes to the database 14 immediately, and another professionals involved in the process (such as a pharmacist) may then immediately take the appropriate action based on the doctor's observation. Thus, the device 10 allows professionals involved in the treatment process to make immediate input for the process, and the input will immediately allow others involved in the process to take actions accordingly. Thus, the system 2 allows the treatment process to be carried out effectively without delay, and conveniently.

Computer System Architecture

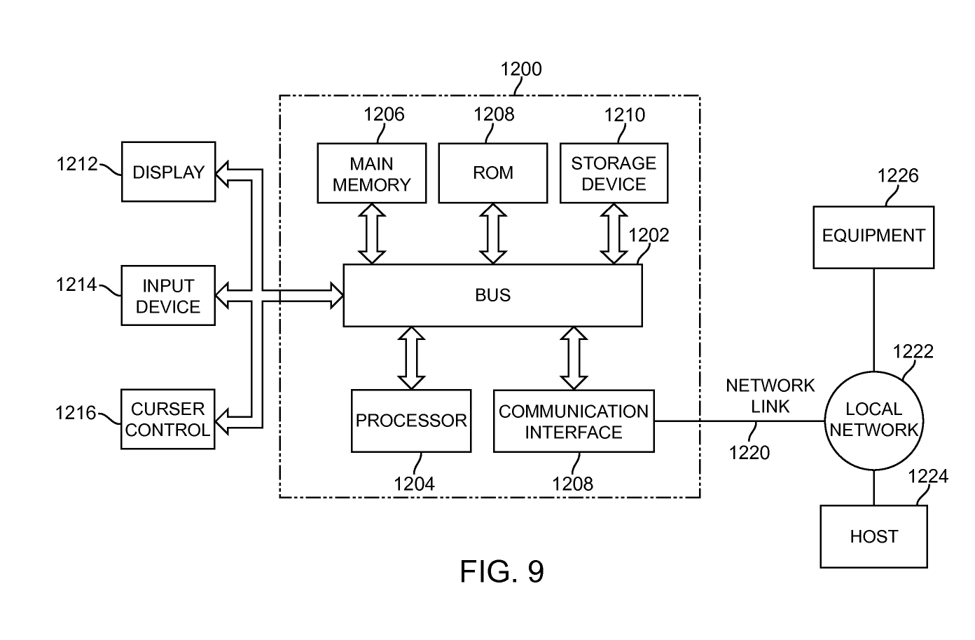

FIG. 9 is a block diagram that illustrates an embodiment of a computer system 1200 upon which embodiments of the features of the user interface 10 may be implemented. In some embodiments, the computer system 1200 may be used to implement the database 14 or the device 10 of FIG. 1. Computer system 1200 includes a bus 1202 or other communication mechanism for communicating information, and a processor 1204 coupled with the bus 1202 for processing information. The processor 1204 may be configured to perform various functions described herein. The computer system 1200 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution of instructions to be executed by the processor 1204. The computer system 1200 further includes a read only memory (ROM) 1208 or other static storage device coupled to the bus 1202 for storing static information and instructions for the processor 1204. A data storage device 1210, such as a magnetic disk or optical disk, is provided and coupled to the bus 1202 for storing information and instructions.

The computer system 1200 may be coupled via the bus 1202 to a display 1212, such as a cathode ray tube (CRT) or a flat panel, for displaying information to a user. An input device 1214, including alphanumeric and other keys, is coupled to the bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The computer system 1200 may be used for performing various functions (e.g., calculation) in accordance with the embodiments described herein. According to one embodiment, such use is provided by computer system 1200 in response to processor 1204 executing one or more sequences of one or more instructions contained in the main memory 1206. Such instructions may be read into the main memory 1206 from another computer-readable medium, such as storage device 1210. Execution of the sequences of instructions contained in the main memory 1206 causes the processor 1204 to perform various processes described herein. One or more processors in a multi-processing arrangement may also be employed to execute the sequences of instructions contained in the main memory 1206. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1204 for execution. Such a medium may take many forms, including but not limited to, non-volatile media, volatile media, and transmission media. Non-volatile media (an example of non-transitory media) includes, for example, optical or magnetic disks, such as the storage device 1210. Volatile media (another example of non-transitory media) includes dynamic memory, such as the main memory 1206. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the computer system 1200 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received by the main memory 1206 may optionally be stored on the storage device 1210 either before or after execution by the processor 1204.

The computer system 1200 also includes a communication interface 1218 coupled to the bus 1202. The communication interface 1218 provides a two-way data communication coupling to a network link 1220 that is connected to a local network 1222. For example, the communication interface 1218 may be an integrated services digital network (ISDN) card or a modem to provide a data communication connection to a corresponding type of telephone line. As another example, the communication interface 1218 may be a local area network (LAN) card to provide a data communication connection to a compatible LAN. Wireless links may also be implemented. In any such implementation, the communication interface 1218 sends and receives electrical, electromagnetic or optical signals that carry data streams representing various types of information.

The network link 1220 typically provides data communication through one or more networks to other devices. For example, the network link 1220 may provide a connection through local network 1222 to a host computer 1224 or to equipment 1226 such as a radiation beam source or a switch operatively coupled to a radiation beam source. The data streams transported over the network link 1220 can comprise electrical, electromagnetic or optical signals. The signals through the various networks and the signals on the network link 1220 and through the communication interface 1218, which carry data to and from the computer system 1200, are exemplary forms of carrier waves transporting the information. The computer system 1200 can send messages and receive data, including program code, through the network(s), the network link 1220, and the communication interface 1218.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A handheld electronic device, comprising:
a network communication device for wirelessly receiving information regarding a plurality of tasks involved in a treatment process for a patient from a database;
a processor for processing the information regarding the plurality of tasks;
a housing containing the processor, wherein the housing is configured for handheld; and
a screen configured to display a graphic using the information regarding the plurality of tasks, the graphic indicating the plurality of tasks on respective dates in a time line.

2. The device of claim 1, wherein the plurality of tasks comprises two or more of doctor consultation, insurance verification, diagnostic imaging, imaging processing, contouring of organ structures, treatment planning, treatment preparation, treatment execution, dose verification, doctor's follow-up, and pain management.

3. The device of claim 1, wherein the network communication device is also configured to receive an additional information comprising one or more of an identification of a treatment procedure identification, a treatment target identification, a date of the treatment procedure, a location of the treatment procedure, a name of an operator of a treatment machine, radiation dose, an identification of an imaging procedure, an identification of a target for the imaging procedure, a date of the imaging procedure, a location of the imaging procedure, and a name of an operator of an imaging machine; and
wherein the screen is configured to display the additional information.

4. The device of claim 1, wherein plurality of tasks are assigned to at least two different persons.

5. The device of claim 1, wherein:
the network communication device is also configured to wirelessly receive information regarding a chemotherapy from the database or from another database;
the processor is further configured to process the information regarding the chemotherapy; and
the screen is further configured to display the information regarding the chemotherapy.

6. The device of claim 5, wherein the information regarding the chemotherapy comprises one or more of RBC, WBC, hematocrit, hemoglobin, MCV, MCH, MCHC, BUN, CO2, Creatinine, glucose, Serum Chloride, Erum Postassium, and Serum Sodium.

7. The device of claim 5, wherein the information regarding the chemotherapy comprises a graph showing different levels of blood count for a patient at different respective dates.

8. The device of claim 1, further comprising an input device configured to receive an input from a user.

9. The device of claim 8, wherein the input device is a part of the screen.

10. The device of claim 8, wherein:
the input device allows the user to enter notes regarding one or more of patient's demographics, patient's vitals, patient's medical history, a patient's treatment, and a patient's diagnosis;
the processor is configured to process the notes; and
the network communication device is configured to wirelessly transmit the notes to the database or another database.

11. The device of claim 8, wherein the input prescribes a location at a body part that is desired to be imaged.

12. The device of claim 8, wherein the input prescribes a location at a body part that is desired to be treated.

13. The device of claim 8, wherein the processor is configured to cause the screen to display a first graphic representing different parts of a patient, and a second graphic for selecting one of the parts of the patient, and wherein the input device is configured to allow the user to selectively move the second graphic relative to the first graphic.

14. The device of claim 1, wherein the device comprises an iPad, an iPhone, a cell phone, an emailing device, or a tablet.

15. A method performed by a handheld electronic device, comprising:
wirelessly receiving information regarding a plurality of tasks involved in a treatment process for a patient from a database;
processing the information regarding the plurality of tasks using a processor; and
displaying on a screen a graphic using the information regarding the plurality of tasks, the graphic indicating the plurality of tasks on respective dates in a time line.

16. A computer product having a non-transitory medium storing a set of instructions, an execution of which causes a process to be performed by a handheld electronic device, the process comprising:
wirelessly receiving information regarding a plurality of tasks involved in a treatment process for a patient from a database;
processing the information regarding the plurality of tasks; and
displaying on a screen a graphic using the information regarding the plurality of tasks, the graphic indicating the plurality of tasks on respective dates in a time line.

17. A system, comprising:
a processor configured to receive information regarding a plurality of tasks involved in a treatment process for a patient, the tasks associated with respective dates; and
a non-transitory medium configured to store the information regarding the plurality of tasks, and the dates;
wherein the processor is also configured to receive a request from a handheld device, retrieve the stored information regarding the plurality of tasks and the dates from the non-transitory medium in response to the request, and pass the information regarding the plurality of tasks and the dates downstream for transmission to the handheld device.

18. The device of claim 17, wherein the plurality of tasks comprises two or more of doctor consultation, insurance verification, diagnostic imaging, imaging processing, contouring of organ structures, treatment planning, treatment preparation, treatment execution, dose verification, doctor's follow-up, and pain management.

19. The device of claim 17, wherein the non-transitory medium is also configured to store an additional information comprising one of the plurality of tasks comprises one or more of an identification of a treatment procedure identification, a treatment target identification, a date of the treatment procedure, a location of the treatment procedure, a name of an operator of a treatment machine, radiation dose, an identification of an imaging procedure, an identification of a target for the imaging procedure, a date of the imaging procedure, a location of the imaging procedure, and a name of an operator of an imaging machine.

20. The device of claim 17, wherein plurality of tasks are assigned to at least two different persons.

21. The system of claim 17, wherein:
the processor is also configured to receive information regarding a chemotherapy from the database or from another database;
the non-transitory medium is configured to store the information regarding the chemotherapy; and
the processor is also configured to receive an additional request from a handheld device, retrieve the stored information regarding the chemotherapy from the non-transitory medium in response to the additional request, and pass the information regarding the chemotherapy downstream for transmission to the handheld device

22. The system of claim 21, wherein the information regarding the chemotherapy comprises one or more of RBC, WBC, hematocrit, hemoglobin, MCV, MCH, MCHC, BUN, CO2, Creatinine, glucose, Serum Chloride, Erum Postassium, and Serum Sodium.

23. The system of claim 21, wherein the information regarding the chemotherapy comprises a graph showing different levels of blood count for a patient at different respective dates.

24. The system of claim 17, wherein the processor is configured to receive notes regarding one or more of patient's demographics, patient's vitals, patient's medical history, a patient's treatment, and a patient's diagnosis, transmitted from a handheld device, process the notes, and transmit the processed notes to the non-transitory medium.

25. The system of claim 17, wherein the processor is configured to receive an input prescribing a location at a body part that is desired to be imaged.

26. The system of claim 17, wherein the processor is configured to receive an input prescribing a location at a body part that is desired to be treated.

27. The device of claim 17, wherein the processor is configured to receive the information regarding the treatment process from a first data source, and to receive the information regarding the imaging process a second data source.

28. A method for providing medical information, comprising:
receiving information regarding a plurality of tasks involved in a treatment process, the tasks associated with respective dates;
storing the information regarding the plurality of tasks and the dates in a non-transitory medium;
receiving a request from a handheld device;
retrieving the stored information regarding the plurality of tasks and the dates from the non-transitory medium in response to the request, wherein the act of retrieving is performed using a processor; and
passing the information regarding the plurality of tasks and the dates downstream for transmission to the handheld device.

29. A computer product having a non-transitory medium storing a set of instructions, an execution of which causes a process to be performed, the process comprising:
receive information regarding a plurality of tasks involved in a treatment process, the tasks associated with respective dates;
storing the information regarding the plurality of tasks and the dates;
receiving a request from a handheld device;
retrieving the stored information regarding the plurality of tasks and the dates in response to the request; and
passing the information regarding the plurality of tasks and the dates downstream for transmission to the handheld device.
